(19) United States
(12) Patent Application Publication
(10) Pub. No.: US 2022/0325914 A1
(43) Pub. Date: Oct. 13, 2022

(54) A BATTERY DEVICE FOR A VENTILATION SYSTEM

(71) Applicant: ENJAY AB, Malmö (SE)

(72) Inventors: Hans LEKEBERG, Eslöv (SE); Nils LEKEBERG, Furulund (SE)

(21) Appl. No.: 17/634,051

(22) PCT Filed: Jul. 29, 2020
(86) PCT No.: PCT/SE2020/050756

§ 371 Date: Feb. 9, 2022

(30) Foreign Application Priority Data
Aug. 12, 2019 (SE) 1930266-0
Jan. 28, 2020 (SE) 2030023-2
Jan. 28, 2020 (SE) 2030024-0
Mar. 30, 2020 (SE) 2030109-9

(51) Int. Cl. F24F 12/00; F28F 9/013; F28F 21/06; F28F 17/00; B33Y 80/00

(52) U.S. Cl. CPC F24F 12/002; F28F 9/0131; F28F 21/062; F28F 17/00; B33Y 80/00; F24F 2221/22; F28F 19/02

(57) ABSTRACT

A heat exchanger (10′) arranged to exchange energy with a flow (F) of air, said heat exchanger (10′) comprises a housing (11) arranged to receive said flow (F) of air through a first end (11a) and at least one conduit arrangement (12) arranged inside said housing (11) whereby said flow (F) of air will pass along the at least one conduit 5 arrangement (12) when said flow (F) of air is received by said housing (11), wherein the heat exchanger (10′) is arranged to be used in a a system where air is carrying particles, such as a marine environment, a kitchen system or a dryer system.

### TECHNICAL FIELD

The present invention relates to a battery device for a ventilations system and in particular a ventilation system in a an environment where particles are present in the exhaust air, and in particular to a battery device in a ventilation system, in particular a ventilation system in a marine environment, a kitchen environment, a textile drying environment, or other system used with air carrying particles.

### BACKGROUND

Most ventilation systems in newer residential and office buildings that contain both exhaust air and supply air deploy energy recycling equipment. The general aim is to extract the energy from the warm exhaust air and, via a heat exchanger device, transfer the energy into the cold supply air to pre-warm it, using recycled energy. Such a part can for example be a cross-stream air-to-air exchanger configured to transfer the inherent energy in the exhaust air to the supply air utilizing metal flanges, or a rotating air-to-air exchanger where the energy exchange is achieved by means of a rotating disc transferring the energy from the exhaust air to the supply air.

Such a part can also be a battery device which is configured to extract inherent energy in the exhaust air mainly utilizing the difference in temperature between the exhaust air and a fluid inside the battery and subsequently reversing the process in the supply air to heat the cool supply air.

Particularly during the cold winter months, regardless of which recycling technology is deployed, this recycled energy cannot raise the temperature of the supply air all the way to the desired temperature needed to keep a comfortable ambient temperature indoors—Therefore, the supply air will be incrementally heated with an extra heating battery, placed downstream of the recycling battery. This battery is connected to the building's heating system, utilizing whatever means of heating that is deployed, for example district heating, gas or electricity to infuse the supply air with the incremental energy needed to achieve the desired temperature.

To protect the technical equipment designed to extract the energy from the warm exhaust air, the flowing exhaust air is always filtered before it is led into the energy recycling equipment. Such filtration normally consists of bag filters, designed to capture particles that otherwise might get stuck on the recycling equipment and there, as a first detrimental effect, deteriorate the efficiency of the energy exchange. As a second detrimental effect, the particles can start blocking the path of the exhaust air, resulting in an increased resistance, which means the fans will have to work harder to extract the required air volumes from the building, thus increasing the energy bill. In the extreme case, the particles building up might eventually block up the equipment to an extent that the air flow cannot be maintained, resulting in a seriously deteriorated indoor air quality.

As one aim is to reduce the energy needed, by recycling the energy (heat or cold), it is a serious drawback if the energy needed to drive the air flow through the recycling equipment would substantially detract from the total net amount of energy recycled by the system.

In ventilation systems for marine vessels, marine structures or similar establishments different types of air borne salt particles create severe issues for the technical equipment designed to extract the energy from the warm exhaust air.

In ventilation systems for textile drying, such as in clothes dryers or other dry tumblers, different types of lint particles create issues for the technical equipment designed to extract the energy from the warm exhaust air. They also clog up the exhaust system, requiring additional power to transport he exhaust air through the exhaust system.

The problem with these particles is that they will—very quickly—clog up the traditional bag filters used to protect the recycling equipment as well as corrode the equipment. Traditionally, such recycling equipment is thus not useful in ventilation systems that handles airflow containing such contaminants.

As will be discussed in the summary below, the inventors have realized after insightful and inventive reasoning that these problems are similar to the problems experienced in kitchen ventilation systems and are therefore proposing to treat the problems in a similar manner.

There is also a problem in the prior art in that manufacturing, assembling and mounting traditional systems having both a filter and a battery unit requires time and leads to high costs.

### SUMMARY

An objective has been to find a new technical solution that would enable to extract the inherent energy in exhaust air (for example from restaurant, bakery, marine or dryer and similar ventilation systems) robustly, over time, even when handling air carrying lots of contaminants, i.e. particles.

It should be noted that the teachings herein may be applied to both heating systems as well as cooling systems, where heating energy is extracted and recycled in heating systems and cooling energy is extracted and recycled in cooling systems.

An objective has been to find a new technical solution that would enable to extract the inherent energy also in air (for example for marine environments, dryer systems as well as from restaurant, bakery and similar ventilation systems) without having to deploy and try to protect energy recycling units that are designed for other types of ventilation systems, i.e. energy recycling units for residential and office ventilation, which cannot survive in the extreme environment. The new technical solution is a totally new type of energy extraction unit, specifically designed to be able to survive, that is to operate efficiently over time, in the aggressive environment occurring in ventilation systems in marine environments, textile dryer systems restaurants, bakeries and similar operations represent, without any need for pre-filtration of the air by means of a separate air cleaning technology and with the inherent, specifically designed-in ability to manage the air borne particles that would clog up the traditional energy recyclers. The teachings herein is basically applicable to any ventilation system where the exhaust air carries particles.

The battery device according to herein, and the ventilation system comprising such a battery device, is thus arranged to be used in marine environments, dryer systems as well as from restaurant, bakery and similar ventilation systems.

For the context of this application, marine environments are taken to include marine vessels, marine structures and any building, housing or other structure needing heating and/or ventilation close to salt-water, such as in harbors, ports and seaside towns and villages.

For the context of this application, dryer systems are taken to include ventilation systems in specific machinery as well as in rooms or plants housing such machinery.

These objectives are achieved by a technique defined in the appended independent and dependent claims and where certain embodiments are being set forth in the related dependent claims.

In a first aspect, there is provided a battery device for a ventilation system, arranged to receive a flow of air, configured to extract energy from the flow of air, said battery device comprises: a housing arranged to receive said flow of air through a first end and at least one bent conduit arrangement arranged inside said housing to extend in a direction from the first end of the housing to a second end of the housing, whereby said flow of air will pass along the bent conduit arrangement when said flow of air is received by said housing, wherein said at least one bent conduit arrangement comprises at least a first conduit and a second conduit arranged in a bent pattern extending in the direction of the bent conduit arrangement parallel to the flow of air or tilted at a small angle relative the direction of the flow of air, wherein the first conduit is arranged interleaved with the second conduit, wherein the bent pattern comprises bent sections and straight sections, the straight sections being arranged horizontally and in a first direction relative the flow of air.

For the context of the teachings herein, horizontal should be understood to be in the range of 2 to −2 degrees seen in the direction of flow of air.

As the bent conduit arrangements are arranged parallel to the flow of air, the bent sections will also be arranged substantially horizontal. This insightful arrangement of the bent conduits being arranged horizontally or slightly tilted enables for the fluid to be transported through the conduits at a minimum or at least reduced pressure drop. Furthermore, interleaving the conduits enables a greater number of conduits to be used (and at greater length) than prior art systems using the same amount of energy to pump the fluid. This provides for an increased heat exchange (as the heat exchange surface is increased substantially compared to prior art systems using the same amount of energy) making the battery device according to the teachings herein highly energy efficient, especially compared to prior art systems.

In one embodiment, the battery device comprises at least two bent conduit arrangements wherein a first bent conduit arrangement is arranged parallel to a second bent conduit arrangement at a vertical distance. The flow of air is thus enabled to pass through the battery device substantially unhindered, while still providing a sufficient surface for heat exchange between the flow of air and the fluid due to the insightful arrangement of the bent conduit arrangements. Furthermore, most, if not all, of the (unwanted) particles in the flow of air will thus also pass through the battery device without colliding with the internal structure of the battery device and clogging up the battery device. The battery device according to herein thus does not require any pre-filtering as in prior art systems.

In a second aspect there is provided a self-cleaning battery device, wherein the at least one conduit has an outer surface, the conduit being configured to receive a fluid, wherein the conduit is configured to have a first temperature and a second temperature, wherein when the conduit has the first temperature, condensation and a particle layer of pollutants is formed on the outer surface of the conduit, and wherein when the conduit has the second temperature the condensation freezes and subsequently cracks the particle layer such that the particle layer is detached from the conduit, thereby self-cleaning the battery device.

In a third aspect there is provided a method for self-cleaning of a battery device, wherein the method comprises: causing the at least one conduit to assume a first temperature, whereby condensation and a particle layer of pollutants is formed on the outer surface of the at least one conduit; and causing the conduits to assume a second temperature, whereby the condensation and the particle layer freezes and subsequently cracks such that the particle layer is detached from the at least one conduit.

The battery device according to herein is arranged to be highly efficient providing for a minimum in pressure drop both in the fluid and in the exhaust air while providing a maximum heat exchange. The battery device according to herein also does not need any pre-filtering.

The battery device is also easy to manufacture and assemble and enables for operation using a minimum of energy.

One aspect of the invention is to utilize a battery device as herein in a ventilation system (as herein) as an energy battery to facilitate additional recycling of the energy in the ventilation system, thus reducing the amount of energy having to be purchased from a utility company and also eliminate or at least reduce the need for any pre-filtering.

The arrangements according to herein provide for a simple and elegant solution to several problems that have been prevalent in the industry for several years, even decades.

According to one aspect a battery device comprising a conduit arrangement where the bent sections are replaced or provided by a generally shaped transport channel is also provided. There is thus provided a battery device arranged to be installed in a ventilation system and arranged to extract energy from a flow of air, said battery device comprises: a housing arranged to receive said flow of air through a first end and at least one conduit arrangement arranged inside said housing to extend in a direction from the first end of the housing to a second end of the housing, whereby said flow of air will pass along the conduit arrangement when said flow of air is received by said housing, wherein said at least one conduit arrangement comprises a plurality of conduits comprising straight sections interconnected with transport channels, the straight sections being arranged horizontally and in a direction substantially orthogonal relative the flow of air, and wherein the conduits are arranged to receive and transport a fluid in a general direction opposite the flow of air.

In one embodiment at least one of said at least one conduit arrangement comprises at least a first conduit and a second conduit, wherein the first conduit is arranged interleaved with the second conduit.

In one embodiment the conduit and the second conduit are arranged in a pattern extending horizontally by being arranged at a tilt angle (gamma) being in the range of 5 to −5 degrees relative the direction of the flow of air.

In one embodiment the first conduit is parallel to the second conduit in the straight sections.

In one embodiment the distance (D1) between the first conduit and the second conduit in a straight section equals the distance (D2) between two straight sections.

In one embodiment a first conduit arrangement is arranged parallel to a second conduit arrangement at a vertical distance (D3). In one embodiment the battery device further comprises a distribution conduit arranged at the second end of the housing to distribute a fluid to each conduit of the bent conduit arrangement and a collection conduit arranged at the first end of the housing to collect the fluid after it has been transported through said conduits.

In one embodiment the battery device is connected to a heat exchange system.

In one embodiment at least one conduit arrangement is provided by a 3D printer.

There is also provided a method for providing a battery device according to herein, wherein the method comprises 3D printing at least one conduit arrangement.

The inventors have realized that the ingenious design provided herein render the material used for the conduits less relevant, whereby the whole design (or parts of it) may be manufactured in plastic materials and may thus even be 3D printed.

According to one aspect a heat exchanger arranged to exchange energy from a flow of air, said heat exchanger comprising a housing arranged to receive said flow of air through a first end and at least one conduit arrangement arranged inside said housing whereby said flow of air will pass along the conduit arrangement when said flow of air is received by said housing, wherein said at least one conduit arrangement comprises a plurality of conduits comprising straight sections interconnected with transport channels, the straight sections being arranged horizontally and in a direction substantially orthogonal relative the flow of air, and wherein the conduits are arranged to receive and transport a fluid in a general direction opposite the flow of air, wherein at least one of said at least one conduit arrangement is 3D printed from a plastic material.

In one embodiment the at least one conduit arrangement is arranged to extend in a direction from the first end of the housing to a second end of the housing, wherein said at least one conduit arrangement comprises a plurality of conduits comprising straight sections interconnected with transport channels, the straight sections being arranged horizontally and in a direction substantially orthogonal relative the flow of air, and wherein the conduits are arranged to receive and transport a fluid in a general direction opposite the flow of air.

Other embodiment discussed herein with reference to the battery device also apply to the heat exchanger.

There is also provided a method for providing a heat exchanger according to herein, wherein the method comprises 3D printing at least one conduit arrangement from a plastic material.

Other embodiments are disclosed in the detailed description and in the attached claims and other benefits are also disclosed in the description herein.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1 is a schematic view of a ventilation system according to an embodiment of the invention,

FIG. 2 is a schematic view from above of a bent conduit arrangement according to one embodiment of the teachings herein to be used in a battery device according to an embodiment of the invention used in the ventilation system in FIG. 1,

FIG. 3A is a schematic view of a bent conduit arrangement according to one embodiment of the teachings herein,

FIG. 3B is a schematic view of a bent conduit arrangement according to one embodiment of the teachings herein,

FIG. 4A is a schematic view of an arrangement of bent conduit arrangements according to one embodiment of the teachings herein,

FIG. 4B is a schematic view of an arrangement of bent conduit arrangements according to one embodiment of the teachings herein,

FIG. 5 is a schematic view of an arrangement of bent conduit arrangements according to one embodiment of the teachings herein,

FIG. 6 is a schematic side view of a bent conduit arrangement according to one embodiment of the teachings herein,

FIG. 7 is a schematic view of an assembly of supports to be used with bent conduit arrangements according to one embodiment of the teachings herein,

FIG. 8 is a schematic view of how a plurality of supports can be used in a bent conduit arrangement according to one embodiment of the teachings herein,

FIG. 9 is a schematic view of a ventilation system according to an embodiment of the invention,

FIGS. 10A, 10B, 10C and 10D each show a schematic view of a conduit wall and a layer of pollutants and how they are affected according to the present invention,

FIG. 11 showing a flowchart for a general method of the teachings according to the present invention,

FIG. 12 is a schematic view of an alternative battery device according to herein,

FIG. 13 is a schematic view from above of an alternative conduit arrangement according to one embodiment of the teachings herein to be used in a battery device according to an embodiment of the invention used in the ventilation system in FIG. 1,

FIG. 14 is a schematic view from above of an alternative conduit arrangement according to one embodiment of the teachings herein to be used in a battery device according to an embodiment of the invention used in the ventilation system in FIG. 1,

FIG. 15 is a schematic view from above of an alternative conduit arrangement according to one embodiment of the teachings herein to be used in a battery device according to an embodiment of the invention used in the ventilation system in FIG. 1,

FIG. 16 is a schematic side view of a conduit arrangement according to one embodiment of the teachings herein,

FIG. 17 is a schematic view of a 3D printer utilized for providing at least one conduit arrangement according to one embodiment of the teachings herein,

FIG. 18 is a flowchart of a general method for utilizing a 3D printer for providing at least one conduit arrangement according to one embodiment of the teachings herein, and

FIG. 19 is a schematic view of a heat exchanger constructed along the principals according to one embodiment of the teachings herein.

### DETAILED DESCRIPTION OF EMBODIMENTS

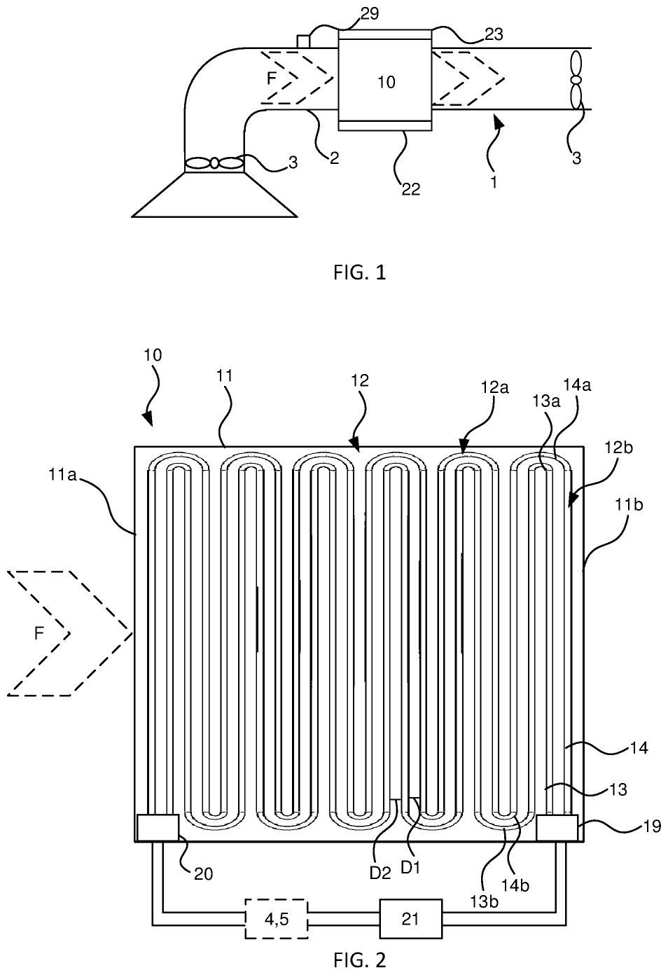

With reference to the drawings, FIG. 1 is a schematic side-view of a ventilations system 1 with a duct 2 and a battery device 10 arranged along the duct 2 so that the duct 2 may lead exhaust air through the battery device 10. The ventilation system 1 as such can be any known type of ventilation system and is not limiting the features of the battery device 10. The ventilation system 1 can even be located in an environment where exhaust air contains unwanted particles such as grease, zoot, dust, salt, lint or other types of particles which needs to be effectively managed. Such an environment can for example be a marine environment, dryer system or large scale restaurant kitchen, a bakery or any other where unwanted particles are created during use.

These types of particles may be of different sizes and shapes. A typical range of particle sizes for more than 95% of the sample mass of a troublesome pollutant—grease—is from 2 μm up to 25 μm.

The battery device 10 is designed and arranged to receive a flow F of air, such as exhaust air possibly containing unwanted particles (not shown in FIG. 1), flowing through the duct 2 of the ventilation system 1. The flow F of air is achieved and/or enforced by a fan unit 3. The fan unit may be located towards the front-end and/or the back-end of the ventilation duct 2. The fan unit 3 can be any type of fan unit used in ventilation systems today.

The battery device 10 presented below is enabled to extract energy from the flow of exhaust air due to temperature differences between the flow of air and the conduits of the battery device 10 that the air passes through. This is explained in more detail below. The battery device 10 presented below is also able to keep the battery device clean enough for efficient operation in contaminated exhaust air, without the need for any pre-filtration. That is, the battery device according to the present invention is efficient and robust enough to operate even when no pre-filtration is provided, as the structure of the battery device 10 according to herein is not prone to clogging. The battery device according to herein is also able to self-clean any particles that do adhere to the metal surfaces of the battery device.

The extracted energy may then be re-distributed into the energy system of a building, for example in the building in which the ventilation system is installed, utilizing the extracted energy where it is needed and/or beneficial. The extracted energy may also or alternatively be redistributed to other systems as needed.

In order to achieve the above purposes, the battery device 10 includes a plurality of conduits 13,14 through which the exhaust air flows. The conduits 13,14 are arranged in horizontally arranged bent conduit arrangements 12.

FIG. 2 shows a schematic top view of a battery device 10 according to the teachings herein. As can be seen, the battery device 10 comprises a bent conduit arrangement 12 comprising two conduits, a first conduit 13 and a second conduit 14. It should be noted that even though only one bent conduit arrangement 12 is shown in FIG. 2, this is purely for illustrative purposes, and a battery device 10 would comprise a plurality of bent conduit arrangements 12, as will be illustrated below. It should also be noted that even though the bent conduit arrangement 12 is exemplified as having two conduits, a bent conduit arrangement may comprise three, four or even more conduits, as will also be illustrated below.

As can be seen in FIG. 2, the battery device is arranged to receive a flow of (exhaust) air, referenced ‘F’, through a first end 11a, to guide the flow F over the bent conduit arrangement 12 and then out of the second end 11b of the battery device 10. The bent conduit arrangement extends in a direction substantially parallel to the flow of the air, and horizontally, comprising a plurality of straight sections 12b of conduit that are arranged substantially perpendicular to the flow of air, also horizontally.

The first conduit 13 and the second conduit 14 of the bent conduit arrangement 12 of FIG. 2 are interleaved so that they run substantially parallel in substantially the same horizontal plane (with reservations to manufacturing variations) back and forth across the flow F of air. This enables for a large surface of the conduits to interact with the flow of air using only a small volume for the battery device 10.

Compared to using a single conduit that is bent more times and allowed to run back and forth across the flow of air, the use of several conduits reduces the pressure drop in each conduit, thereby reducing the energy needed to pump a fluid through the conduits, thereby also reducing the energy consumption of the battery device 10.

The straight sections 12b are connected by bent sections 12a. In one embodiment, the straight sections 12b and the bent sections 12a are made of separate pieces that are to be joined.

In one embodiment, the straight sections 12b and the bent sections 12a of at least one conduit are formed by the same conduit, by the conduit being bent or bent repeatedly. This has the benefit of reducing the time and cost for manufacturing and assembling the battery device.

In one embodiment, the straight sections 12b and the bent sections 12a of at least one conduit are formed by the one or more conduits, by the conduits being bent or bent repeatedly and joined together.

Using bent conduits also has the benefit in simplifying the distribution and collection of cooling fluids. As the conduits are bent, only one point of distributing and one point for collecting are needed, which reduces the cost for manufacturing the collection and distribution conduits as well as assembling the battery device 10. As will be clear from the below, using the same collection and distribution conduits for several bent conduit arrangements also reduces the cost for manufacturing and assembling the battery device.

As the conduits 13, 14 are arranged horizontally, the bent sections will also be arranged horizontally. This ensures that no air (or other gas) bubbles are captured in the bends, which ensures that the work required for the pump that circulates the cooling fluid is maintained at an acceptable level and that the pressure drop in the conduits is kept low.

In order for the first and second conduits to be interleaved, the bent sections 12a are made up of bent sections 13a, 13b, 14a, 14b for the first and the second conduits that are repeated alternatingly. In the example of FIG. 2, the first conduit 13 comprises a first bent section 13a and a second bent section 13b, wherein the first bent section 13a is arranged on one side of the bent conduit arrangement 12, and the second bent section 13b is arranged on the opposite side of the bent conduit arrangement 12. Likewise, the second conduit 14 comprises a first bent section 14a and a second bent section 14b, wherein the first bent section 14a is arranged on one side of the bent conduit arrangement 12, and the second bent section 14b is arranged on the opposite side of the bent conduit arrangement 12. The first and the second bent sections are repeated alternatingly across the length of the conduit and the bent conduit arrangement 12. In the example of FIG. 2, the first bent section 13a of the first conduit 13 matches the first bent section 14a of the second conduit 14 in such a manner that the first conduit 13 runs parallel—or substantially equidistant—to the second conduit 14 also through the bent section 12a.

In the example of FIG. 2, the first bent section 13a of the first conduit 13 equals the second bent section 14b of the second conduit 14, and the first bent section 14a of the second conduit 14 equals the second bent section 13b of the first conduit 13.

In one embodiment a bent section may be a radially curved portion of conduit.

In one embodiment a bent section may be a bent portion of conduit.

In one embodiment a bent section may be a bent portion followed by a straight portion followed by another bent portion.

In one embodiment, the bent sections are arranged to be substantially 180 degrees, seen from an inlet of the bent section to an outlet of the bent section. In one embodiment, the bent sections are arranged to be in the range 178-182 degrees. In one embodiment, the bent sections are arranged to be in the range 175-185 degrees. In one embodiment, the bent sections are arranged to be in the range 170-190 degrees. In one embodiment, the bent sections are arranged to be in the range 160-200 degrees. The greater the angle of a bent section, the area of the straight sections can be housed in a given area/volume. The smaller the angle, the less drop in pressure of the fluid. The angles possible are also dependent on the length of the straight sections and the distance between the straight sections. A compromise may therefore be made and the inventors have found that an angle of 180 degrees provide for a good compromise that is also easy to install.

For an angle differing from 180 degrees, the straight sections may not be truly parallel, but will be discussed herein as being parallel in the meaning that they run in the same horizontal plane.

The bent sections may be continuous (or smooth). The bent sections may also or alternatively be discontinuous. In one such embodiment, the bent section is stepwise discontinuous using substantially straight portions. In one alternative or additional such embodiment, the bent section is stepwise discontinuous using substantially straight portions connected by smooth bends.

A bent section thus comprises at least one bent portion and possibly one or more straight portions. A straight portion need not be strictly straight, but can be a portion having a curvature with a large radius.

In one embodiment, the bent sections are arranged to be semi-oval.

In one embodiment, the bent sections are arranged to be semi-circular.

In one embodiment, the bent sections are arranged to be U-shaped.

In one embodiment, each bent conduit arrangement 12 comprises more than 5 bent sections for each conduit 13, 14. In one such embodiment, each bent conduit arrangement 12 comprises more than 9 bent sections for each conduit 13, 14. In one such embodiment, each bent conduit arrangement 12 comprises more than 15 bent sections for each conduit 13, 14. In one such embodiment, each bent conduit arrangement 12 comprises more than 25 bent sections for each conduit 13, 14. In one such embodiment, each bent conduit arrangement 12 comprises more than 35 bent sections for each conduit 13, 14.

A conduit may have bent sections of the same type or of varying or different types.

As the number of bent sections for a conduit grows, the surface for heat exchange also grows. However, the pressure drop for the fluid in the conduit will also grow. Therefore, as the inventors have realized, it is better to use interleaved conduits instead of increasing the length (number of bent sections) of a conduit, as the surface for heat exchange will remain the same, while not increasing the pressure drop for the fluid.

In order for the conduits to be interleaved, the first and second bent sections for the first conduit are not of the same radius or extent in the case of a non-radially curved bent section, one bent section being smaller than the other to enable the interleaving of conduits 13, 14, by one bent section partially encompassing the other bent section.

In one embodiment, a bent section of a first conduit is arranged to match a corresponding bent section of the second conduit by the conduits being at an equal distance (equidistant) to each other through the bent section.

In one embodiment, a bent section of a first conduit is arranged to match a corresponding bent section of the second conduit by the outer conduit being arranged to accommodate or partially enclose the inner conduit through the bent section.

In one embodiment, the bending radius of the smaller bent section is equal to 1.5 to 2.5 times the diameter of the conduit. In one embodiment, the bending radius of the smaller bent section is equal to 1.75 to 2.25 times the diameter of the conduit In one embodiment, the bending radius of the smaller bent section is equal to or larger than twice the diameter of the conduit.

This ensures that any fluid that is transported through the conduit will travel unhindered and decreases the turbulence in the conduit.

In one embodiment, the bent section of the smaller bent section is made utilizing bending machines based on a technique not deforming the inner radius of the bent section, for example booster functionality. In such an embodiment, the bent section radius may be smaller than twice the diameter of the conduit.

The pairs of conduits (i.e. the first and the second conduits) making up a straight section 12b is arranged at a section distance (indicated D2 in FIG. 2) from another pair of conduits, i.e. the next section. By placing the straight sections at a distance from one another enables the passing air to enter this void so that any turbulence caused by the conduits may evolve and also increases the exposed surface between the air in the air flow F and the conduits 13, 14, which increases the heat exchange between the fluid in the conduits and the air.

In one embodiment the section distance is 14 mm. In one embodiment the section distance is in the range 12 to 16 mm. In one embodiment the section distance is in the range 10 to 20 mm. In one embodiment the section distance is in the range 5 to 30 mm.

In one embodiment the section distance is dependent on the diameter of the conduit. In one such embodiment the section distance is in the range 2-5 times the diameter of the conduit. In one such embodiment the section distance is in the range 2-3 times the diameter of the conduit. In one such embodiment the section distance is 2 times the diameter of the conduit.

Along the straight sections, the first and second conduits 13, 14 are arranged at conduit distance (indicated D1 in FIG. 2) from one another. For straight sections not running parallel, the distance is an average or a mid-point distance. By keeping the conduit distance low, more conduits may be housed in the same area, thus increasing the use of space making the battery device smaller for the same number of straight sections and conduit surface exposed to the flow of air. The conduit distance D1 is therefore smaller than or equal to the section distance D2.

In one embodiment the conduit distance is 14 mm. In one embodiment the conduit distance is in the range 12 to 16 mm. In one embodiment the conduit distance is in the range 10 to 20 mm. In one embodiment the conduit distance is in the range 5 to 30 mm.

In one embodiment the conduit distance is dependent on the diameter of the conduit. In one such embodiment the conduit distance is in the range 2-5 times the diameter of the conduit. In one such embodiment the conduit distance is in the range 2-3 times the diameter of the conduit. In one such embodiment the conduit distance is 2 times the diameter of the conduit.

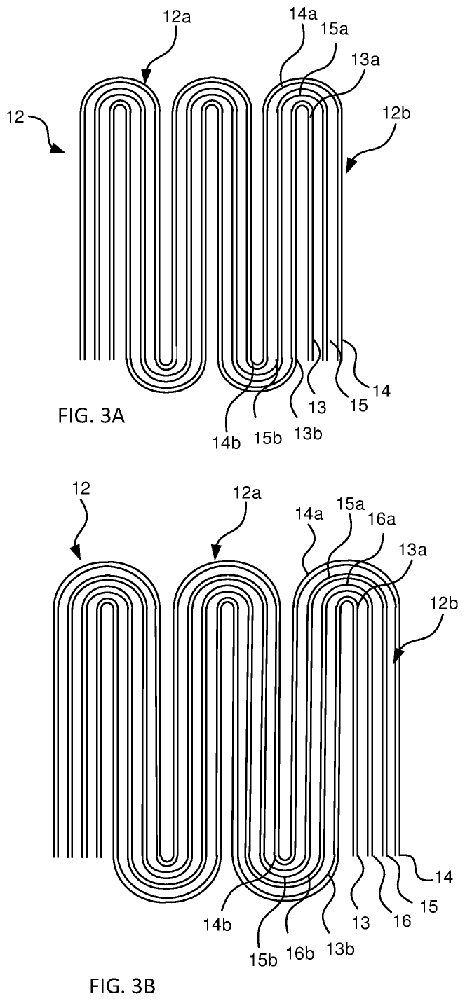

FIGS. 3A and 3B each show a schematic top-view of an alternative embodiment of a bent conduit arrangement 12 as per the teachings herein. As mentioned above, a bent conduit arrangement 12 may comprise more than two conduits, and FIG. 3A shows an example where a bent conduit arrangement 12 comprises a first conduit 13, a second conduit 14 and a third conduit 15. As can be seen, the conduits are approximately equidistant in the bent sections 12a and parallel in the straight sections 12b. The third conduit 15 is arranged between the first conduit 13 and the second conduit 14. The third conduit 15 is, in one embodiment, arranged with a bent section that is repeated over the third conduit's extension in the bent conduit arrangement 12.

FIG. 3B shows an example where a bent conduit arrangement 12 comprises a first conduit 13, a second conduit 14, a third conduit 15 and a fourth conduit 16. As can be seen, the conduits are approximately equidistant in the bent sections 12a and parallel in the straight sections 12b. As can be seen, the fourth conduit 16 is arranged in between the first conduit 13 and the second 14 adjacent the third conduit 15.

In one embodiment, the third conduit 15 is arranged bent utilizing a first 15a and a second 15b bent section, the fourth conduit 16 is arranged bent utilizing a first 16a and a second 16b bent section, wherein the first bent section 15a of the third conduit 15 corresponds to the first bent section 16a of the fourth conduit 16 and the second bent section 15b of the third conduit 15 corresponds to the second bent section 16b of the fourth conduit 16.

In one embodiment, two (or more) bent conduit arrangements may be arranged nestled or interleaved as an alternative or in addition to, having more conduits in the bent conduit arrangement. In such an embodiment, the section distance will then vary between sections to accommodate a section from the nestled bent conduit arrangement.

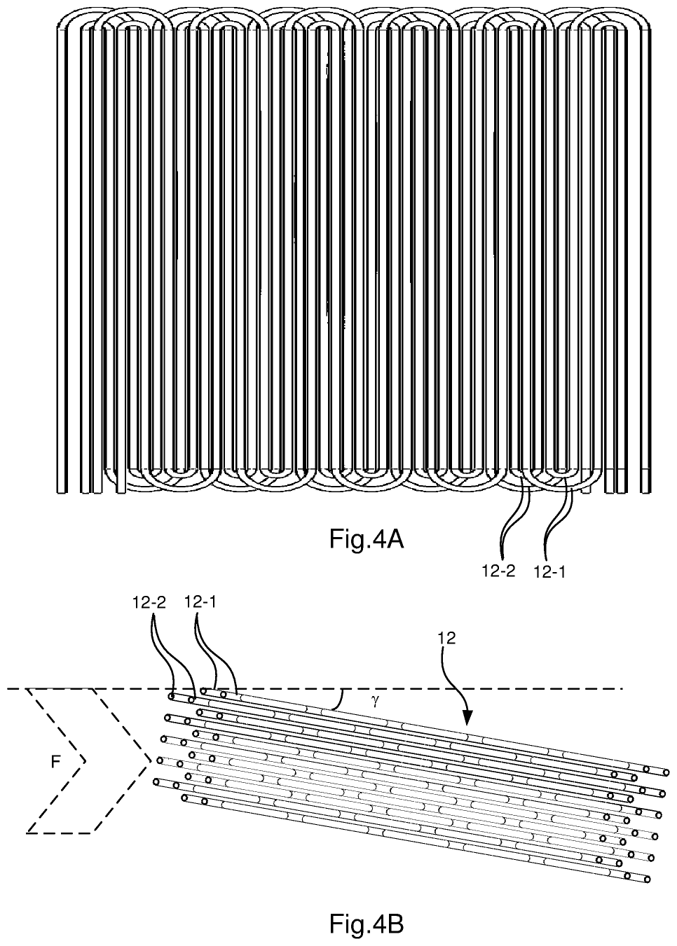

As mentioned above, a battery device 10 according to the teachings herein comprises more than one bent conduit arrangement 12, and FIG. 4A shows a schematic top-view of a battery device 10 comprising a first bent conduit arrangement 12-1 and a second bent conduit arrangement 12-2. For illustrative purposes only two bent conduit arrangements are shown in FIG. 4A. As can be seen the first bent conduit arrangement 12-1 is arranged on top of the second bent conduit arrangement 12-2. By stacking the bent conduit arrangements on top of one another, several bent conduit arrangements 12 may be housed in the same battery device 10.

In one embodiment, the first bent conduit arrangement 12-1 is arranged straight on top of the second bent conduit arrangement 12-2. This has the benefit of making the overall size of the battery device, and the size of the distribution and collection conduits small.

In one embodiment, the first bent conduit arrangement 12-1 is arranged on top of the second bent conduit arrangement 12-2, but offset in the direction of the flow of air. In one embodiment, the first bent conduit arrangement 12-1 is offset the second bent conduit arrangement 12-2 by an offset distance (referenced D4 in FIG. 6). This has the benefit of reducing the turbulence created between the bent conduit arrangements when the flow of air is received, thereby allowing for a minimized pressure drop.

In one embodiment the offset distance is 14 mm. In one embodiment the offset distance is in the range 12 to 16 mm. In one embodiment the offset distance is in the range 10 to 20 mm. In one embodiment the offset distance is in the range 5 to 30 mm.

In one embodiment the offset distance is dependent on the diameter of the conduit. In one such embodiment the offset distance is in the range 2-5 times the diameter of the conduit. In one such embodiment the offset distance is in the range 2-3 times the diameter of the conduit. In one such embodiment the offset distance is 2 times the diameter of the conduit.

The first bent conduit arrangement 12-1 is arranged at a vertical distance D3 from the second bent conduit arrangement 12-2.

In one embodiment, the vertical distance D3 is 3 to 7 mm. In one embodiment, the vertical distance is 5 mm.

In one embodiment, the vertical distance D3 is proportional to the diameter of the conduit. In one such embodiment, the vertical distance D3 is in the range 0.5 to 1 times the diameter of the conduit.

The vertical distance D3 is, in one embodiment, a minimum distance between the two bent conduit arrangements. Some conduits may be at a larger distance from one another, but not a smaller.

The vertical distance D3 is, in one embodiment, an average distance between the two bent conduit arrangements.

By ensuring a (minimum) vertical distance between the bent conduit arrangements, the flow of air is provided with passages to flow through, thereby reducing the pressure drop and/or the power needed to drive the flow of air through the battery device and the pressure drop of the air flow can be kept at a low and acceptable level. The actual minimum distance needed depends on the air flow and the required minimum pressure drop.

FIG. 4B shows a side-view of a conduit arrangement 12 according to the teachings herein comprising at least a first and a second bent conduit arrangement 12-1, 12-2. As can be seen the bent conduit arrangements may be arranged tilted relative the flow of air. In one embodiment, this is achieved by arranging a front portion of the bent conduit arrangement at a higher position, than a rear portion of the conduit arrangement. FIG. 4B illustrates a tilt angle gamma, which is greatly exaggerated for illustrative purposes. The tilt angle is, in one embodiment, in the range 5 to −5 degrees relative the direction of the flow of air, as indicated by the dashed line in FIG. 4B. The tilt angle is, in one embodiment, in the range 1 to −5 degrees. The tilt angle is, in one embodiment, in the range 1 to −2 degrees. By arranging the conduit arrangement 12 at a tilt angle, where the front portion is higher than the rear portion, it will be easier to transport any gas bubbles out of the system. As the tilt angle is relatively small, the flow of air will still be allowed to flow unhindered through the battery device 10.

The tilt angle is, in one embodiment, substantially 0 degrees (with reservations to manufacturing variations).

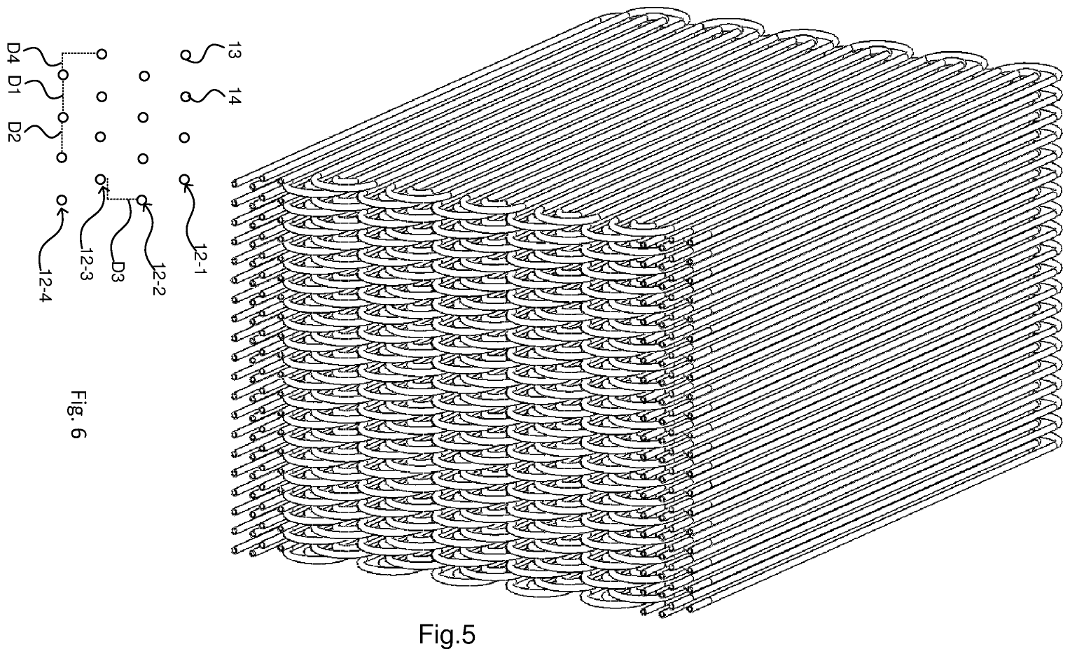

FIG. 5 shows a schematic side-view of an arrangement of bent conduit arrangements 12 comprising a realistic number of bent conduit arrangements 12. In the example of FIG. 5, there are forty (40) bent conduit arrangements 12 all stacked and alternatingly offset one another.

FIG. 6 shows a schematic side-view of a cross-sectional cut-out, showing the openings of the conduits 13, 14 of several bent conduit arrangements 12-1-12-4. In FIG. 6, the various distances D1-D4 are shown, and in the example of FIG. 6, the distances D1-D3 are substantially equal and the offset distance D4 approximately equaling half the other distances (D4=D1/2).

In one embodiment a battery device 10 according to herein comprises 30 to 80 bent conduit arrangements, each comprising 10 to 20 bent sections.

Utilizing a battery device as per herein, has several benefits, and provides an improved heat exchange. This improved heat exchange is in part due to the arrangement of the bent conduits and the relationship between the distances between the conduits. The heat exchange in a battery device as per herein has been found to be so efficient that the actual material of the conduits is of less importance. However, in one embodiment, the conduit is made of brass or a brass alloy. In one embodiment, the conduit is made of an aluminum alloy. In one embodiment, the conduit is made of a copper or copper alloy. In one embodiment, the conduit is made of stainless steel. In one embodiment, the conduit is made of plastic.

In one embodiment, the bent conduit arrangements are kept in place by their connections to the distribution 19 and collection conduits 20.

In one embodiment, the bent conduit arrangements 12 are kept at the minimum distance from one another also by supports 17 being arranged between at least some of the bent conduit arrangements 12. This has the benefit that the conduits may be made of thinner material and especially that the connections to the distribution and collection conduits may be made less robust.

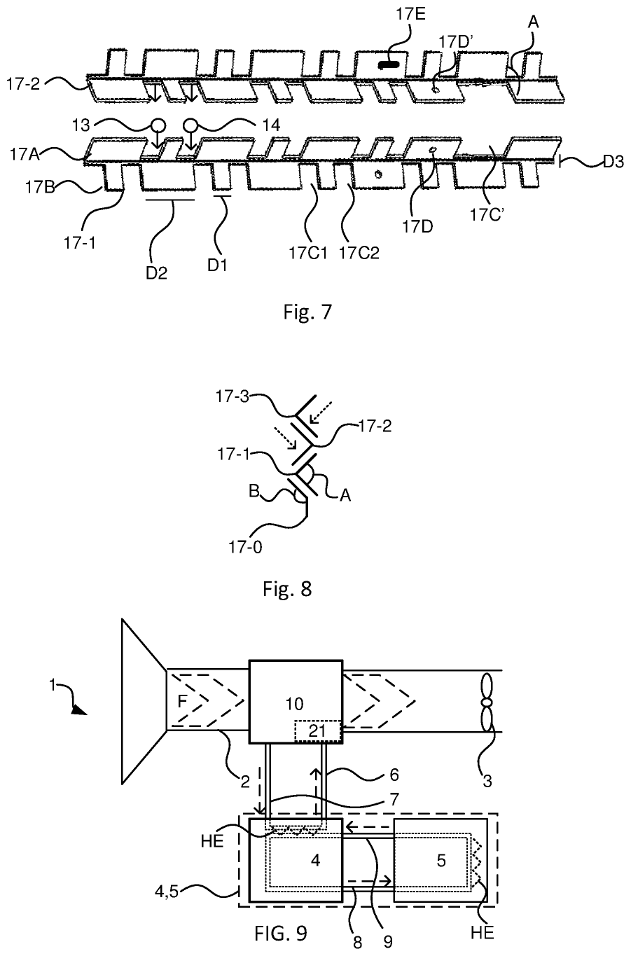

FIG. 7 shows a schematic side view of two supports 17-1 and 17-2. Each support is arranged with a first (upper) side 17A and a second (lower) side 17B. At least one side is arranged with at least one cut-out 17C, that may be circular, semi-circular, rectangular, U-shaped or otherwise shaped and sized to receive a conduit 13, 14 (or 15, 16 not shown in FIG. 7). It should be noted that the length of the supports may vary as per the length of the bent conduit arrangement 12, and the length in FIG. 7 is chosen for illustrative purposes and is arranged to hold 4 to 5 straight sections.

In one embodiment, the cut-outs 17C are arranged in groups, where the number of cut-outs in the group correspond to the number of conduits in the bent conduit arrangement. In the example shown in FIG. 7, there are two cutouts 17C1 and 17C2 in each group.

The distance between each cutout 17C in a group substantially corresponds (within variances due to machining and to allow for tolerances) to the distance between conduits in a straight section; D1. The distance between each cutout group substantially corresponds (within variances due to machining and to allow for tolerances) to the distance between straight sections; D2.

The distance between cutouts 17C in a first side 17A and the cutouts in a second side 17B of a support 17 group substantially corresponds (within variances due to machining and to allow for tolerances) to the distance between bent conduit arrangements; D3.

In one embodiment, the cutouts 17C are sized and shaped to receive each a conduit 13, 14 of each straight section. In FIG. 7, this is indicated by cutouts 17C1, 17C2. This enables a more stable arrangement, preventing or reducing any vibration in the conduits.

In one embodiment, the cutouts 17C are sized and shaped to receive a conduit section, i.e. the first, second and so on conduit of each straight section. In FIG. 7, this is indicated by cutout 17C′. This enables a lighter support (saving on materials cost) and an easier mounting.

As is disclosed with relation to the conduit distance D1 and the section distance D2 above, the cutout distances may also be equal.

When mounting the bent conduit arrangements 12 and the supports 17, the conduits 13,14 of a first bent conduit arrangement 12 (not shown in FIG. 7) are mounted or placed within the cutouts 17C (such as 17C1, 17C2, 17C′) of a first (upper) side 17A of a first (lower) support 17-1, as indicated by the arrows in FIG. 7. A second (upper) support 17-2 is then placed on top so that the cutouts 17C of the second (lower) side 17B of the second (upper) support 17-2 receives the conduits 13, 14, as indicated by the arrows in FIG. 7. As can be seen in FIG. 7, the sections between cutouts may overlap, in one embodiment, when the supports are mounted.

In one embodiment, there is arranged a hole 17D in at least one section between two cutouts 17C in the first support 17-1. In one such embodiment, there is arranged a corresponding hole 17D′ in a corresponding section between two cutouts 17C in the second support 17-2. In an alternative or additional such embodiment, there is arranged a corresponding pin 17E in a corresponding section between two cutouts 17C in the second support 17-2.

By aligning a hole 17D with a corresponding hole 17D, the two supports 17-1 and 17-2 may be attached to one another by inserting a screw, pin, bolt or other attachment means (not shown) through the holes 17D and 17D′. Alternatively or additionally, the pin 17E is inserted into and through the hole 17D to attach the two supports.

By attaching the supports to one another, a more stable arrangement is provided.

In one embodiment, as shown in FIG. 7, the first side 17A and the second side 17B of a support 17 are arranged at a support angle A to one another. This enables an easier assembly or mounting as the attachment means may be inserted from above at an angle, instead of from the side, which at mounting is inside the bent conduit arrangement 12.

In one embodiment, the cutouts 17C are rectangular. In one embodiment, the cutouts 17C are U-shaped. In one embodiment, the cutouts 17C are semi-circular.

FIG. 8 shows a schematic view of how a plurality of supports 17-1, 17-2, 17-3 may be mounted with relation to one another, where the supports may be joined at an angle, as indicated by the dashed arrows.

In one embodiment, there may be a base support 17-0 at the lower or upper end of the arrangement for simplifying the mounting as if the support is leaned at an angle to a supporting structure it will not stand by itself until it is joined to another support. In one embodiment, such base support 17-0 is part of, comprised in or joined to the housing 11. In one embodiment, the base support 17-0 is arranged so that the upper side 17A is arranged with cutouts 17C (and the lower is not, apart from cutouts for reducing the weight or receiving other structures). In one embodiment, the base support 17-0 is arranged so that the upper side 17A is arranged at a second angle B relative the lower part, where the second angle B substantially equals half the angle A plus 90 degrees.

Returning to FIG. 1, the battery device 10 is, in one embodiment, arranged in a ventilation system 1. However, it should be noted that the battery device may be arranged in any system, where energy is to be extracted from an air (or other gas) flow.

In operation, the battery device 10 further comprises a fluid that the battery device is arranged to receive, such as a refrigerant. The fluid is to be transported through the conduits 13, 14. In one embodiment, the fluid is brine. The fluid is, in one embodiment, configured to cool the conduits 13, 14 which in turn will cool the surrounding exhaust air. It should be noted that the fluid may alternatively be used to heat the conduits. A common temperature of such a flow F of exhaust air is between 20° C. and 32° C. and a common temperature of the transported fluid is between −10° C. and 20° C. which means that a temperature drop of between 4° C. and 18° C. of the exhaust air can be achieved. Thus, the (cooling) fluid and the arrangement of conduits 13, 14 are configured to extract energy from the flow F of exhaust air by cooling the exhaust air, and also by extracting the energy released as parts of the water content in the exhaust air condensates.

In prior art battery devices, a pre-filtration is required as the battery devices will otherwise clog up too quickly to operate efficiently.

The battery device 10 of the present invention is, however, constructed in such a manner that no pre-filtering is needed. The design of the battery device disclosed herein minimizes the pressure drop of the flow of air, and thus allows the flow of air to pass (relatively) unhindered.

This is enabled by the bent section arrangement's aerodynamic qualities which allows for the flow of air to pass (relatively) unhindered through the battery device thereby allowing the pollution particles (e.g. grease, soot, moisture, etc.) to also pass through the battery device, without colliding with and adhering to the internal structure (bent section arrangements and so on) of the battery device 10, preventing or at least reducing the risk of the battery device clogging up.

The battery device 10 is thus capable of operating in contaminated air without the need for pre-filtering.

Returning to the battery device 10 the cooling fluid is arranged to run in a closed loop between the conduits 13, 14 of the battery device 10 and an optional thereto connected pump by means of two pipes. The pump can be replaced by for example a heat exchanger, a heat pump or any other suitable device, such as the heating system 4,5 discussed below, but for now will be referred to as a pump. The pump feeds the cooling fluid which has been cooled to the right temperature. A preferred temperature of the cooling fluid when entering the battery device 10 is between −10° C. and 20° C. As the cooling fluid has passed through the conduits 13, 14 of the battery device 10 and cooled the conduits 13, 14, the cooling fluid returning now has a higher temperature. The cooling fluid is, within the closed loop, again cooled to the right temperature by any suitable device before returning to the battery device 10 and the conduits 13, 14. The difference in temperature between the cooling fluid and the returning cooling fluid can be between 4° C. and 18° C. The extracted energy from the flowing exhaust air can be used to reduce the energy consumption of the overall system, for example, heat the building or room in which the ventilation system 1 operates. It should also be noted, as discussed above, that the teachings herein may equally well be applied in a cooling system, where energy is extracted and reused for cooling.

FIG. 9 shows a schematic view of a system 1, where a battery device 10 in a ventilation system, such as that of FIG. 1, is used as a battery device for heat exchange system 4, 5. It should be noted that many variations are possible for connecting the battery device of the present invention with a heat exchange system and FIG. 9 only shows one example. In one example, the heat exchange system is a heating system, where energy is extracted and reused for heating. It should also be noted, as discussed above, that the teachings herein may equally well be applied in a cooling system, where energy is extracted and reused for cooling.

The heat exchange system 4, 5 generally comprises a first unit 4 and a second unit 5. In one embodiment, the first unit 4 is a pump arranged to receive a fluid from the battery device 10 through conduit 7 and transport the fluid to the second unit 5 through conduit 8. In such an embodiment the fluid of the battery device is allowed to undergo heat exchange (HE) with a medium of the heat exchange system, for example for heating or cooling supply air thereby recycling or reusing the energy extracted by the battery device. The fluid is then returned to the battery device through conduits 9 and 6.

In one embodiment the first unit is a heat pump arranged to receive and return a fluid from the battery device 10 through conduits 6 and 7 and allow the fluid received from the battery device 10 to undergo heat exchange (HE) with a fluid of the heat exchange system which is transported between the first unit 4 and the second unit 5 through conduits 8 and 9. In such an embodiment the fluid of the heat exchange system is then allowed to undergo heat exchange with a medium of the heat exchange system, for example for heating or cooling supply air thereby recycling or reusing the energy extracted by the battery device.

Such heat exchange systems 4, 5 are known and require no further explanation, and it should be noted that since they are so well-known many details and variations have been left out for reasons of conciseness. For example, in the embodiment where the first unit 4 is a pump, the pump of the heat exchange system may be implemented or replaced by a pump 21 of the battery device 10, the two systems sharing a pump.

Returning to FIG. 2, the battery device 10 further has a distribution conduit 19 arranged to receive the fluid (cooling fluid in the example of a heating system and heating fluid in the example of a cooling system) from the pump 21. As is indicated in FIG. 2 by the dashed box referenced 4,5, the fluid may also be pumped through an additional or external system 4,5 as discussed in relation to FIG. 9. The distribution conduit 19 is arranged to distribute the fluid to each one—or at least a plurality—of the conduits 13, 14 of a bent conduit arrangement 12. Further, the battery device 10 includes a collection conduit 20 arranged to receive the fluid after it has been transported through the conduits 13, 14 of a bent conduit arrangement 12 and return it to the pump 21, possibly via a heating system 4,5.

In one embodiment the distribution conduit 19 is arranged to distribute the fluid to a plurality of bent conduit arrangements 12, and in one such embodiment the distribution conduit 19 is arranged to distribute the fluid to all of the bent conduit arrangements 12 of the battery device 10.

Similarly, in one embodiment the collection conduit 20 is arranged to collect the fluid from a plurality of bent conduit arrangements 12, and in one such embodiment the collection conduit 20 is arranged to collect the fluid from all of the bent conduit arrangements 12 of the battery device 10.

Such collective distribution and collection is made possible by the clever arrangement of bent conduit arrangements, enabling for a minimum pressure drop in the fluid. This also enables for a simplified manufacturing and installation.

In the example embodiment of FIG. 2, the distribution conduit 19 is arranged downstream of the flow of air F, and the collection conduit 20 is arranged upstream. This enables a more efficient heat exchange.

A water distribution device, here called a sprinkler device 23 may further be included in either the battery device 10 and/or in the ventilation system 1. Advantageously, the sprinkler device 23 can gather heated water from a chamber 22 for cleaning the battery device 10.

A shunting valve 29 may also be arranged in the ventilation system 1.

The battery device 10 as described above has many advantages. The battery device 10 may extract energy to be further used in a heating system, even without pre-filtering. In known ventilation systems these two features (the (heat) battery and the pre-filtering) are separate, using two different units to accomplish both filtering and energy extracting. This has not been beneficial since, for example, the amount of necessary cleaning and maintenance work that needs to be done regularly is too extensive and not as efficient as with the battery device 10 presented above. Also, the pre-filtering brings about an unavoidable pressure drop in the flow of air, which either leads to a lower efficiency of the heat exchange in the battery device, or must be compensated for, which increases the power consumption of the system, also leading to a lower energy efficiency of the system. Often the unit enabling the energy extraction is not suited to handle unwanted particles such as grease, soot and similar which, if they stick to the unit, also can affect the efficiency of it. Further, the filter units used today are not able to filter the flow of exhaust air such that the energy extracting unit is totally protected from the unwanted particles. By being robust enough to operate in unfiltered air, not only the efficiency of the ventilations system can be increased but also a less energy demanding fan unit can be used in the ventilation system. This is because the previously used energy extracting unit has created an obstacle in the course in which the exhaust air flows which in turn demands a stronger fan to create the desired flow.

As there will always be some degree of build-up of contaminants—even when using the clever arrangement of the bent conduit arrangements taught herein, the battery device 10 may also be arranged to be self-cleaning.

The battery device is configured to receive a flow of exhaust air containing pollutants, wherein said battery device comprises at least one conduit with an outer surface, the conduit being configured to have a first temperature and a second temperature, wherein when the conduit has the first temperature condensation and a particle layer of pollutants is formed on the outer surface of the conduit, and wherein when the conduit has the second temperature the condensation and the particle layer freezes and subsequently cracks such that the particle layer is detached from the conduit.

This is advantageous since the battery device stays clean and no aggregation of grease particles and other pollutants will clog the battery device. Since it is a self-cleaning process, no aid from a person, or addition of any extra media or chemicals, is needed and the cleaning is performed automatically. To crack the formed layer of pollutants with freezing, results in an efficient cleaning process where no pollutant particles will remain on the surfaces in the battery device, as would be the issue if, for example the chosen method for cleaning would be to try to melt the adhered layer of pollutants off the conduits for example by hot water spray provided by the sprinkler device 23, or by running the fluid at a second (higher) temperature through the conduits.

In one embodiment, there is provided a ventilation system, wherein the at least one conduit is arranged to receive a fluid, which is arranged to assume a first and a second fluid temperature, wherein when the fluid assumes the first fluid temperature, the conduit will assume the first temperature, and when the fluid assumes the second fluid temperature, the conduit will assume the second temperature.

In one embodiment the conduit is caused to assume the second conduit temperature by causing the fluid to assume the second fluid temperature by regulating the temperature of the fluid.

In one embodiment the conduit is caused to assume the second conduit temperature by regulating the airflow.

In one embodiment, there is provided a self-cleaning battery device, wherein the second temperature is in a range between 0 to −60° C. Preferably, the second temperature is between −3 to −20° C., and more preferably between −8 to −12° C. These temperature intervals ensure that the formed ice layer cracks the layer of pollutants.

It should be noted, and as will be explained in the detailed description, that it is not the ice layer that cracks in its structure, but the ice layer cracks the particle layer thus forcing the particle layer to release its cohesion to or grip on the outer surface of the conduit.

In many situations the ventilation system 1 comprising the battery device 10 is located in an environment where exhaust air contains pollutants such as grease, soot, dust, grime or other types of particles, which need to be effectively managed. Such an environment may for example be a marine environment, dryer system or a large scale restaurant kitchen, a bakery or any other environment where pollutants or other particles as described are air borne.

The battery device 10 is designed and arranged to receive a flow F of exhaust air which may contain pollutants flowing into the ventilation duct 2 and trough the battery device 10, where some of the pollutants may collide with the conduits 13, 14 of the battery device and a layer of pollutants is slowly built-up over time.

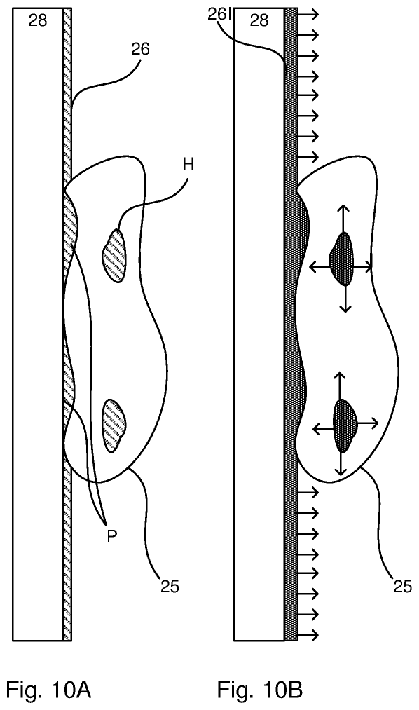

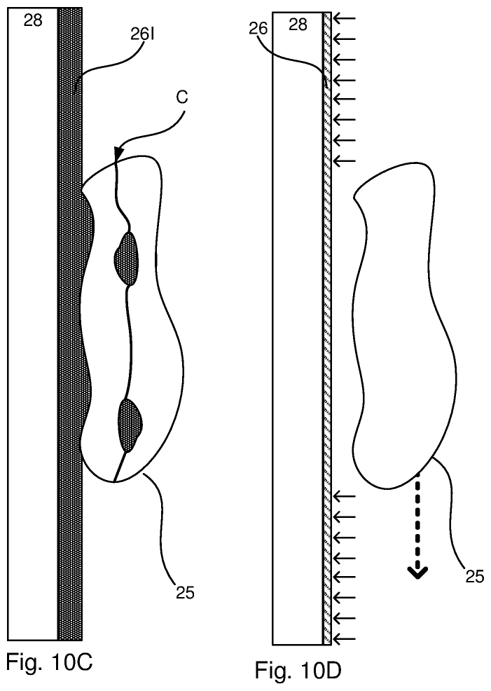

The battery device 10 according to herein, may however, be arranged to be self-cleaning in a clever manner and the description below and with reference to FIGS. 10A-10D show how the battery device 10 is able to remove pollutants from and clean itself, FIG. 10 being a series of schematic views of a conduit wall 28 and a layer of pollutants 25. First, the battery device 10 is arranged in the ventilation system 1. In one embodiment, the conduits 13, 14 of the battery device 10 are then caused to assume a first conduit temperature T_{C1}, or conduit cooling temperature T_{C1}.

In one embodiment causing the conduits to assume a first conduit temperature T_{C1} is accomplished by circulating the fluid having a first fluid temperature T_{F1}. Thus, the conduits 13, 14 assume a temperature T_{C1} close to the temperature T_{F1} of the fluid. Due to the first conduit temperature T_{C1}, condensation will form on the outer surface 28 of the conduits 13, 14.

As the fluid and the conduit will have temperatures that—at least after an initial period after a temperature change has been effected—are substantially the same or at least corresponds to one another due to the heat transfer between the fluid and the conduit, it may be said that changing the temperature of the conduit corresponds to changing the temperature of the fluid and vice versa.

The flow of exhaust air F is provided to the battery device 10 and the air flows in between or next to the conduits 13, 14.

In one embodiment causing the conduits to assume a first conduit temperature T_{C1} is accomplished by the flow of exhaust air, having a relatively high temperature, being higher than the first conduit temperature T_{C1}, which will heat up the conduit (and also the fluid) and cause the conduit to assume the first conduit temperature which depends on the fluid temperature and the temperature in the flow of air.

Particles in the exhaust air flow F will collide with and adhere to the outer surfaces 28 of the conduits 13, 14. A layer of pollutants 25 are thus formed on the surfaces 28.

To remove the pollutant layer 25, i.e. to clean the battery device 10 by a cleaning process, the fluid is caused to assume a second fluid temperature T_{F2}, or freeze temperature. The second temperature T_{F2} is lower than the first temperature T_{F1}. This causes the conduits 13, 14 to assume a second conduit temperature T_{C2} which corresponds substantially to the second fluid temperature T_{F2}.

In one embodiment the fluid is caused to assume the second fluid temperature T_{F2} (and thereby will the conduit be caused to assume the second conduit temperature T_{C2}) by actively changing or regulating the temperature of the fluid, such as by cooling the fluid or by replacing the fluid. In such an embodiment, the fluid is caused to assume the first fluid temperature T_{F1} by actively changing or regulating the temperature of the fluid, such as by heating the fluid or by replacing the fluid.

In one embodiment the fluid is caused to assume the second fluid temperature T_{F2} by causing the conduit to assume the second conduit temperature T_{C2}, thereby cooling the fluid, by adapting the flow of air F. As the inventors have realized, the flow of air has a heating effect on the conduits, and the flow of air can thus be used to regulate the temperature of the conduit 13, 14 causing the conduit to assume different temperatures, possibly without changing the fluid in other manners, by simply adapting the flow of air.

It should be noted that the adaptation of air may be in addition to or as an alternative to adapting or regulating the fluid.

In one embodiment the flow of air is adapted by reducing the flow of air.

In one embodiment the flow of air is adapted by halting the flow of air.

In one embodiment the flow of air is adapted by shunting in cool air in the flow of air. The cool air may be shunted in through a shunting valve 29. The cool air may be outdoor air in which case no additional cooling will be necessary, thereby saving further on energy consumption.

In one embodiment the flow of air is adapted while circulating the fluid. The fluid will thus not be heated as much any longer by the flow of air, and the conduit will assume the second temperature being lower than the first temperature.

As simply adapting the flow of air, especially by reducing, halting or shunting in outside air, does not require any energy to perform, but actually reduces the power consumption, the overall power consumption of the ventilation system is reduced and the cleaning process is highly efficient and environmentally friendly.

The second cooling temperature T_{C2} (in some embodiments the second fluid temperature T_{F2}) is chosen in order to freeze the condensation 26 and the layer of pollutants 25 on the surface 28 of the conduits 13, 14.

The condensation thus turns into a layer of ice 26I. It is to be noted that the conduits 13, 14 are not always necessarily covered by the ice layer 26I.

Only when the cleaning process is underway is the ice layer 26I forced to form on the conduits 13, 14. Thus, energy is not required in order to keep the fluid or conduit at a temperature enough to freeze the condensation 26 at all times. The cleaning process is conducted at regular intervals. The time span between each cleaning event depends on the environment in which the battery device 10 is arranged, the air flow rate etc.

If the battery device 10 is in need of extra moisture in order to form condensation on the outer surface 28, moisture can be added, before causing the conduits 13, 14 to assume the second conduit temperature T_{C2}—by for instance sprinkling water on the conduits 13, 14 with a sprinkle device. Alternatively, or additionally, additional moisture is added before the particles adhere to the conduits. It is favorable to switch off the ventilation system function during the self-cleaning process. However, it is not mandatory to do so.

Such a sprinkle device may also be used to subsequently spray clean the conduits 13, 14.

The conduits 13, 14 are kept at the second temperature T_{C2} until the formed layer of ice 26I and the layer of pollutants 25 crack, forcing the layer of pollutants 25 away from the outer surface 28, due to the low temperatures T_{C2}, T_{F2}. In one embodiment, the conduits 13, 14 are kept at the second temperature T_{C2} by circulating the fluid while adapting the air flow F. The cracked combination of layer of ice 26I and layer of pollutants 25 thus detach the layer of pollutants 25 from the conduits 13, 14 and fall off from the conduits 13, 14, at least when the conduits again assume a higher temperature, such as when the heat exchange system is turned off (whereby no fluid is circulated to cool the conduits), when the fluid is caused to assume a higher temperature or when the ventilation system is activated, whereby the flow of air will heat the conduits.

In the following the process of the cracking the ice layer and particle layer will be disclosed in more detail. As can be seen in FIG. 10A the outer surface 28 of a conduit is shown in enlargement. It should be noted that the series of figures of 10A-10D is not to scale and some proportions have been greatly exaggerated for illustrative purposes, such as the thickness of the condensation layer.

A condensation layer 26 is formed on the outer surface 28 when the conduit temperature is at the first conduit temperature (such as when the first temperature is above 0 degrees Celsius). It should be noted that the condensation layer may be formed through natural adsorption, especially when the conduit is made of metal, whereby no energy is needed for causing the condensation layer to be formed.

The condensation layer may be very thin and need not have a specific thickness. It should be noted though that since the cleaning process disclosed herein actually saves energy, it may be repeated many times and so a high efficiency is not necessary.

The condensation layer may also comprise fluids sprayed into the ventilation system.

As no surface is completely smooth, there will always be some pockets where condensation can be formed.

As is illustrated in FIG. 10A, the layer of pollutants 25 is irregular in its structure and especially its surface. There will thus be formed small pockets (P) of condensation between the layer of pollutants 25 and the outer surface 28 of the conduit. As is also illustrated in FIG. 10A, as the layer of pollutants is irregular and may also have been constructed in layers, possibly comprising several particles that are clumped together, there may also be holes (H) in the layer of pollutants that are filled (at least partially) with condensation or other fluids.

As is known, when liquids, especially water, freezes they expand. FIG. 10B shows how the condensation layer expands as it turns into an ice layer 26I. The expansion is indicated by the arrows indicating the direction of the expansion. As the outer surface 28 of the conduit is impermeable, or at least less permeable than the free air, the ice layer 26I will expand away from the outer surface 28. As it does so, the condensation in the pockets P will also expand and push the layer of pollutants 25 away from the outer surface 28, thereby cracking the ice layer 26I and the layer of pollutants 25.

Furthermore, as the layer of pollutants and the condensation layer does not consist of the same material, they will expand at different rates as they freeze, which will also cause the ice layer 26I and the layer of pollutants 25 to crack.

In addition to this, the holes H of condensation in the layer of pollutants 25 will also expand and possibly cause the layer of pollutants 25 to crack from inside forming cracks C.

FIG. 10C shows the situation when the ice layer 26I has expanded and the layer of pollutants 25 has been distanced from the outer surface 28, that is, after the ice layer 26I and the layer of pollutants 25 has cracked. As the layer of pollutants 25 has been distanced from the outer surface 28 it loses—at least partially—its cohesion to or grip on the outer surface 28. Due to gravity some of the layer of pollutants 25 will fall off already at this point.

It is thus not the ice layer that cracks, but it is the combined layer of the ice layer and the layer of pollutants that cracks as is indicated in the above.

FIG. 10C also shows the situation where cracks C have been formed in the layer of pollutants 25.

As is noted above, the conduits are only kept at the lower temperature for a time period, and then allowed to assume a higher temperature (above 0 degrees Celsius), such as an inactive temperature or the first temperature whereby the ice layer 26I will melt. FIG. 10D shows the situation when the ice layer 26I has melted and returned to a condensation layer 26. This is indicated by the arrows. As is illustrated in FIG. 10D, the layer of pollutants 25 is now distanced from the outer surface 28 and also, there is no ice layer 26I to hold it to the outer surface, and most or at least some of the layer of pollutants 25 will fall off the outer surface 28, as is indicated by the bold dotted arrow.

Due to gravity, later rinsing/spraying and/or the reintroduction of the air flow most of the layer of pollutants 25 will be caused to fall off the outer surface 28.

As noted above, this process is very energy efficient, and may thus be repeated regularly. In case there is a remaining layer of pollutants, as the conduits are caused to assume the first temperature again, a new or the same condensation layer will form, but now in the pockets which have been made larger and also in any holes, which have been made larger, and/or cracks and as the conduits are again caused to assume the second temperature (being below 0 degrees Celsius), the ice layer 26I will again be formed, causing the ice layer and remaining layer of pollutants 25 to crack even more, and distance the remaining layer of pollutants 25 from the outer wall 28 even further, thereby increasing the likelihood of the remaining layer of pollutants 25 to fall off the outer wall 28.

The conduits 13, 14 have thus become cleaned with a self-cleaning process. Thereafter, the conduit is brought back to the first temperature or at least a temperature above 0 degrees Celsius, such as an inactive temperature. In one embodiment, this is achieved by the fluid being brought back to the first fluid temperature T_{F1}. In one embodiment this is achieved by the air flow being re-adapted. Thus, also the conduits 13, 14 assume the first conduit temperature T_{C1} once more and the air cleaning process starts over again. Alternatively, the heat exchange system is turned off completely whereby the conduits assume the inactive temperature, assumingly being above 0 degrees Celsius as at least parts of the ventilation system is arranged indoors.

Should the ventilation system be arranged outdoors and the ventilation system is turned off, the conduits will remain at the lower temperature until the ventilation system is turned back on and the warm air flow from the restaurant recommences. The situation can then utilize the invention by using the turned off period as the period when the conduits are kept at the lower or second temperature and then form the ice layer cracking the ice and particle layer.

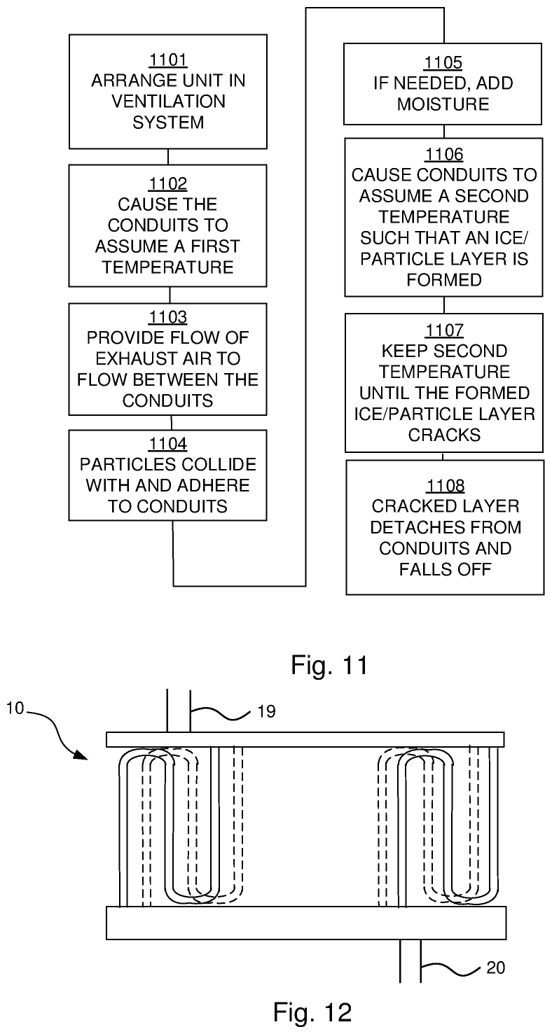

To summarize, with reference to FIG. 11, showing a flowchart of a general method according to herein, the manner of operating the self-cleaning ventilation system according to this application, thus comprises causing the conduits to assume 1102 a first temperature and to provide 1103 a flow of air. The conduits are caused to assume the first temperature by a fluid being circulated in the conduits and by being heated by the air flow. By circulating the fluid at least shortly before providing the flow of air enables for a condensation layer to be formed more efficiently before the flow of air—and the accompanying particles—first contact the conduits. As it will take some time to cool the conduits, the conduits will not freeze immediately upon receiving the fluid. The first temperature—at least as eventually reached during filtering—is above 0 degrees Celsius.

As the air flows through the ventilation system, particles being carried by the air flow will collide and adhere 1104 to the conduits. When they do, small pockets of condensation will be formed under the layer of particles, and as the conduits are caused to assume a second temperature, the condensation will freeze, possibly along with the layer of pollutants, and crack 1107 the layer of pollutants causing the layer of pollutants to lose (at least some of) its adhesion to the outer wall 28 of the conduit 13, 14. The ice layer may also crack due to the freezing. The second temperature—at least as eventually reached—is below 0 degrees Celsius. The conduits are caused to assume the second temperature by the fluid being circulated in the conduits being further cooled and/or by no longer being heated by the air flow—or to a reduced degree. By no longer heating the conduits, possibly by simply turning off the air flow, an energy saving manner of cooling the conduits is achieved as the manner of driving the air flow (possibly the fan) is turned off or down.

The cracked layer of pollutants, and possibly some of the ice layer, detaches 1108 from the conduit, at least when the temperature is brought back to the first temperature, or another temperature, such as an inactive temperature, above 0 degrees Celsius.

The details of the battery device 10 according to one embodiment will now be described in more detail. The fluid is caused to assume the first fluid temperature T_{F1}. The pump 21, pumps the fluid with temperature T_{F1} through the conduits 13, 14.

A preferred value of the first fluid temperature T_{F1} when entering the battery device 10 is between −20° C. and 10° C. The fluid may be arranged to run in a closed system of the battery device 10. The pump 21 can in other embodiments be replaced by for example a heat exchanger, a heat pump or any other suitable device.

In a situation, the conduits 13, 14 have assumed the first conduit temperature T_{C1} by heat transfer from the fluid having the first fluid temperature T_{F1}. The flow of exhaust air F flows into the ventilation system 1 and into the battery device 10.In one embodiment, the conduits 13, 14 have assumed the first conduit temperature T_{C1} by heat transfer from the fluid having the first fluid temperature T_{F1} in combination with being heated by the flow of air.

A common temperature of the flow F of exhaust air is between 18° C. and 35° C. A common value of the first fluid temperature T_{F1} of the fluid is between −20° C. and 10° C. The first conduit temperature T_{C1}, which the conduits 13, 14 assume when the fluid of temperature T_{R1} passes through them, is slightly higher than the first fluid temperature T_{F1}. This is due to the laws of thermodynamics.

This means that a temperature drop of the exhaust air can be achieved. As the flow of air is activated the first conduit temperature, will increase as the conduit (and the fluid) is heated by the flow of air. Thus, the fluid and the arrangement of conduits 13, 14 are configured to extract energy from the flow F of exhaust air by cooling the exhaust air by means of the fluid having the first fluid temperature T_{R1}.

Periodically, the build-up of the particles, i.e. the pollutant layer 25, and condensation on the outer surface 28 of the conduits 13, 14, needs to be removed as is discussed above. That is, the battery device needs to be cleaned. Cleaning is important in order to avoid increased resistance of the air flow and avoid the risk of clogging. Therefore, the temperature of the fluid is decreased to the second fluid temperature T_{R2}. The second fluid temperature T_{F2} is between 0° C. and −60° C., preferably between −3 and −20° C., or between −5° C. and −15° C. and more preferred between −1° C. and −10° C. The self-cleaning effect is enhanced if the second fluid temperature T_{F2} is applied in several cycles or for a longer duration of time. As stated above, the fluid may be caused to assume the second fluid temperature by adapting the airflow as an alternative or in addition to actively cooling the fluid.

Due to the first conduit temperature T_{C1} of the conduits 13, 14, condensation 26 from water bound in the exhaust air has formed on the outer surfaces 28 of the conduits 13, 14. When the fluid is cooled to the second fluid temperature T_{F2} , the conduits 13, 14 assume the second conduit temperature T_{C2}, and the condensation freezes such that a layer of ice 26I is formed on the outer surface 28 of each conduit 13, 14. Since the condensation forms closest to the conduit surface 28 at least a part of the pollutants adhere on top of the condensation, i.e. at least a part of the condensation is beneath the pollutant layer 25.

Eventually, the layer of ice 26I beneath the layer of pollutants 25 expands and thus cracks the pollutant layer 25 due to the lower second fluid temperature T_{F2} . The lower second fluid temperature T_{F2} , compared to the first fluid temperature T_{F1}, causes the layer of pollutants 25 to contract and become brittle, which eventually lead to a blasting or cracking effect. When the layer of ice 26I and layer of pollutants 25 crack, the layer of pollutants 25 detach from and fall off from the conduits 13, 14. In some instances, where the layer of ice has been cracked in itself, the layer of ice 26I also fall off the outer surface 28. This temperature varying process, or freeze process, achieves self-cleaning of the conduits 13, 14 of the battery device 10 in the ventilation system 1. When the ice 26I and pollutant layer 25 has fallen off the conduits 13, 14, the temperature of the fluid is brought back to the first fluid temperature T_{F1} or an inactive temperature, and the process may be started again. The unit may include a controller (not shown), which controls the temperature of the fluid, the interval at which the cleaning takes place, and various optional features, such as alarms for when there is a need for emptying collection means. The controller may e.g. control a compressor, by which the temperature changes of the fluid is handled.

A preferred cleaning interval, i.e. temperature change from the first fluid temperature T_{F1} to the second fluid temperature T_{F2} is once every 24 hours. However, this depends on the amount of particles/pollutants in the exhaust air.

Thus, it is efficient and simple to form a layer of ice 26I on the conduits 13, 14 according to the present invention. The layer of ice 26I can be formed during high load cycles and the layer of pollutants 25 will fall off from the surface 28 of the conduits 13, 14 when the layer of ice 26I cracks the layer of pollutants 25, leaving no melted grease on the surfaces 28. In addition, no further chemicals, such as a surfactant, is needed to achieve a well-functioning self-cleaning process. During use, the flow F of exhaust air is cooled by the cooled conduits 13, 14 and condensation is formed on the outer surfaces 28 of the conduits 13, 14.

Excess condensation water formed in the battery device 10 and on the conduits 13, 14 may be collected by the collection means and transported to a chamber 22. The chamber 22 may also be used for collecting the cracked layer of ice 26I and layer of pollutants 25 during self-cleaning of the battery device 10.

The gathered condensation water and/or layer of ice 26I, can in one embodiment be recycled in the self-cleaning process of the battery device 10. Optionally, the chamber 22 is connected to a heating device which is arranged to heat the ice 26I which has fallen off the conduits 13, 14 sufficiently to melt the ice 26I. If the heating device is not used, the ice 26I will melt due to the temperature being above 0° C. in the collection tray. The condensation water and/or the melted ice 26I can be sprinkled or sprayed on the conduits 13, 14 in order to add extra moisture to the outer surface 28 of the conduits 13, 14. Thus, the conduits 13, 14 can be wetted to ensure that an ice layer 26I is formed thereon to facilitate the cracking process. However, if the melted condensation water is to be recycled, a filter is preferably used to filter away the pollutants prior the sprinkling.

The sprinkler 23 device may further be included in either the battery device 10 and/or in the ventilation system 1. Advantageously, the sprinkler 23 device can gather water from the chamber 22. If the battery device 10 and the conduits 13, 14 need to be cleaned but there is no condensation to form an ice layer 26I, water may be sprinkled onto the conduits 13, 14. If water from the chamber 22 is not enough, the chamber 22 can be connected to and use water from any other suitable water source (not shown), for example a tap in the room where the ventilation system 1 is in use. The sprinkler 23 device and optionally the above described heating device may further be connected to any regular water source if more water is needed during cleaning. It is however an advantage to be able to use the condensation water first and then add water from another source. To recycle the condensation is an advantage since it is a sustainable use of the ventilation system 1, without the necessity to add tap water and waste resources.

The sprinkler 23 device may be of use for instance if the ventilation system 1 and/or the battery device 10 has not been in use for a long time or if the exhaust air is extraordinary dry. The relative humidity of the air alters depending on weather, climate and season for instance. When air is very dry, there is a risk that too little water is present in the air flow F to enable the formation of an ice layer 26I. This is solved by the addition of moisture by means of the sprinkler 23 device.

The battery device 10 as described above has many advantages. The battery device 10 provides a built-in self-cleaning system. The efficiency of the cleaning of the ventilations system is thereby increased and also the risk of clogging in the ventilation system causing poor air quality and foul smell is diminished.

In one embodiment, at least one of the conduits 13, 14 is made of metal, which further improves the adsorption.

In one embodiment, at least one of the conduits 13, 14 is coated to enable the pollutants to lose their adhesion more easily. In one such embodiment, the coating is nano-coating.

FIG. 12 shows a schematic overview of an alternative embodiment, where the distribution conduit 19 and the collection conduit 20 are arranged on opposite sides of the battery device, unlike in previously disclosed embodiments, where the distribution conduit 19 and the collection conduit 20 are arranged on the same side of the battery device. By arranging the distribution conduit 19 and the collection conduit 20 on a same side of the battery device, the installation may be simplified as only one side need to be accessible.

One significant benefit of having a conduit arrangement 12, where straight sections of conduits 12b are joined by bent sections 12a, 13a,13b,14a,14b as disclosed in the above, is that mounting the conduit arrangement 12 becomes very simple as each layer of the composite conduit arrangement 12, i.e. each conduit arrangement 12-1, 12-2, 12-3, 12-4 are simply laid on top of each other using spacers to keep them at a proper distance from one another, where a minimum of joining, such as through welding, is required during the mounting.

However, as the inventors have realized the other advantages and benefits provided by the invention herein is also provided by a conduit arrangement following the same general principles as explained above, but where one or several bent sections are replaced by other forms of transport channels, the bent sections thus only being one example of a transport channels.

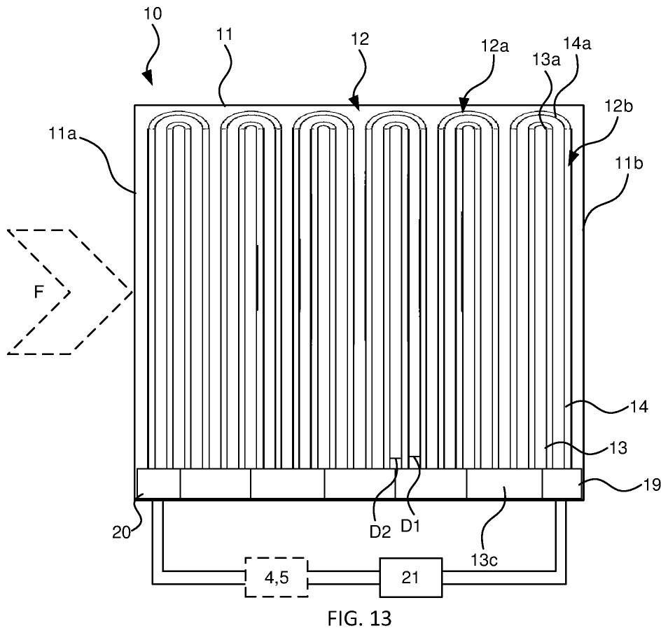

FIG. 13 shows a schematic top view of an alternative battery device 10 according to the teachings herein. In much the battery device comprises the same components as the battery device of FIG. 2, however, some of the bent sections 12a, 13a, 14a have been replaced by transport channels 13c of a different shape. In the example embodiment of FIG. 13, the bent sections on one side of the battery device (lowest side in FIG. 13) has been replaced by such general transport channels 13a and in the example of FIG. 13 the transport channels are shown as being of rectangular shape, indicating a representation of general shape that could also be of other shapes.

The main issue is that the transport channels are arranged so that the fluid being transported from one (first) conduit 12a, 13, 14 into another (second) conduit is substantially horizontally aligned so that there is no (or at least a minimal, i.e. negligible) pressure difference in the fluid being transported from the first conduit to the second conduit, which enables for utilizing an optimally low power for pumping the fluid through the conduits 12, 13, 14 which are also arranged substantially horizontally.

The horizontal arrangement also enables for any air (or other gas) bubbles to not get caught in any bent sections interfering with the flow of the fluid (i.e. the coolant).

The same major benefits as discussed herein are thus also achieved with a conduit arrangement 12 where some of the bent sections 12a, 13a, 14a, 13b, 14b are replaced by generally shaped transport channels 13c, other than that the mounting may require some more joining, which does not effect the efficiency of the battery device 10 during operation. The previously referred to as bent conduits thus do not need to be bent.

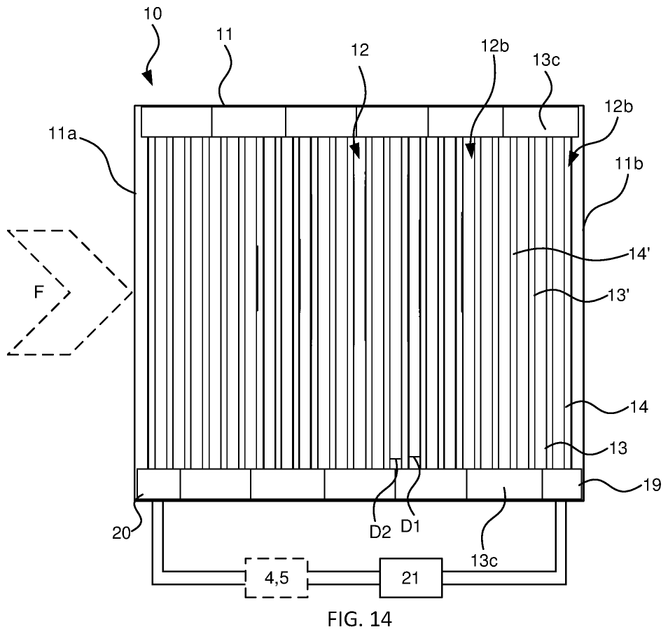

FIG. 14 shows a schematic top view of an alternative battery device 10 according to the teachings herein, where also the bent sections on the other side of the battery device 10 have been replaced by generally shaped transport channels 13c.

In FIGS. 13 and 14, each transport channel serves a plurality of conduits 12, 13, 14 where fluid is being pumped in through two (first) conduits 13, 14 and transported through the transport channel 13c and out of two (second) conduits 13′, 14′. As both first conduits 13, 14 are being fed by the same distribution channel 19, the pressure in them are the same and the fluid will thus successfully be transported into the two second conduits 13′, 14′. The first and second conduit pairs are to be understood to be interleaved in this manner in the context of the teachings of this application.

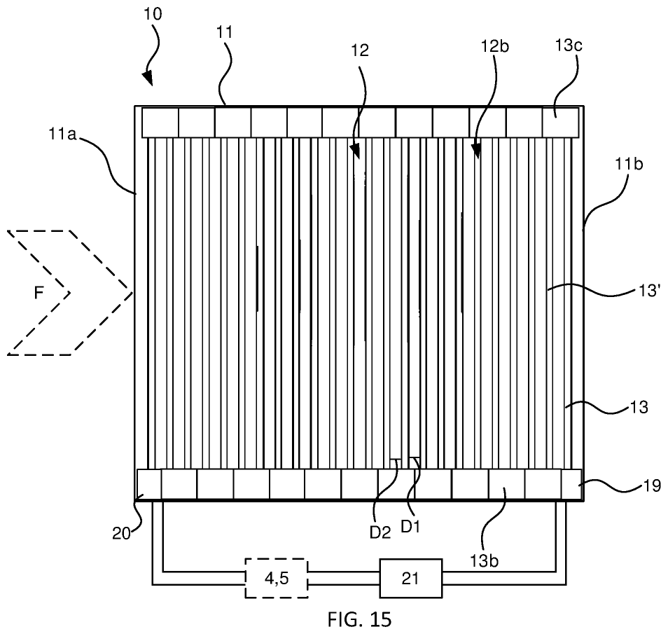

A transport channel may also be arranged to serve any number of conduit pairs, and FIG. 15 shows a schematic top view of an alternative battery device 10 according to the teachings herein, where at least one transport channel 13c serves a single conduit pair (of a first conduit 13 and a second conduit 13′). In the example of FIG. 15 each conduit pair is served by a transport channel 13c (at every end), but it should be understood that any number of and combination of transport channels 13c is possible and within the scope of the teachings herein.

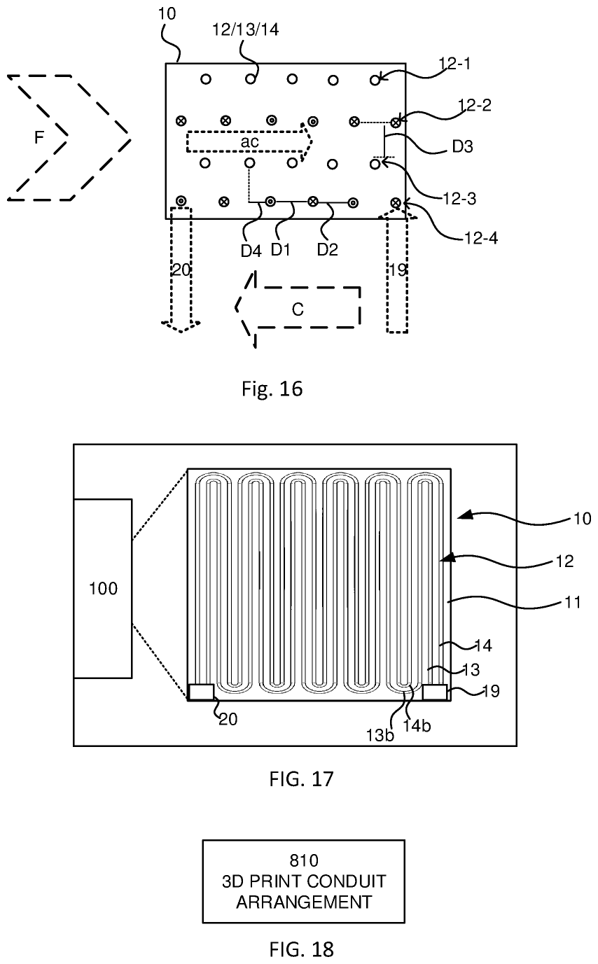

FIG. 16 shows a sideways view of a conduit arrangement 12 when used in a battery device 10 according to herein, the view explaining the main underlying principle of a conduit arrangement 12 according to herein, which conduit arrangement is highly energy efficient when acting as a battery device (as discussed herein). The schematic view of FIG. 16 shows a sideways view of a conduit arrangement where any transport channels are omitted for visibility reasons. As in FIG. 6, the view shows a plurality of conduit arrangements 12-1, 12-2, 12-3, 12-4 arranged in relation to one another. Also as in FIG. 6, the direction of the flow of air (or other gas) is indicated by the big arrow marked “F”. In FIG. 16 the general direction of flow of the fluid in the conduits (i.e. the coolant) is also indicated with an arrow marked “C”. The actual direction of flow of the coolant through the conduits is also indicated by alternating conduits 12 in the lower conduit arrangement 12-4 being marked with dots or x:es to indicate the direction of the flow in that specific conduit.

As can be seen in FIG. 16 the flow of the air F is in a direction opposite to the main (or general) direction of the flow of the coolant C. This provides for an efficient heat exchange serving to increase the efficiency of the battery device 10 making it highly suitable for use as a battery device 10 in a ventilation system 1 (as in FIG. 1 or 9).

Further, and as in FIG. 6, the conduits are arranged substantially horizontally which minimizes the pressure needed to pump the coolant through the conduits and also reduces the impact that any air (or other gas) bubbles may have on the flow, which also minimizes the pressure needed to pump the fluid through the conduits also serving to increase the efficiency of the battery device 10 making it highly suitable for use as a battery device 10 in a ventilation system 1 (as in FIG. 9).

A battery device 10 for use in a ventilation system is thus provided according to the teachings herein where several conduits are arranged to transport a fluid (such as a coolant) in a main direction opposite the flow of air through the battery device, where the conduits are arranged substantially horizontally (within +/−5 degrees, +/−2 degrees, +/−1 degree or at 0 degrees) and substantially orthogonal (within +/−5 degrees, +/−2 degrees, +/−1 degree or at 0 degrees offset the orthogonal direction) to the flow of air.

As discussed especially in relation to FIGS. 13 and 14, the conduits are connected with transport channels (not shown explicitly in FIG. 16) that are also arranged substantially horizontally (within +/−5 degrees, +/−2 degrees, +/−1 degree or at 0 degrees). In some embodiments, at least one of the transport channels is arranged to extend above the conduits. This enables any air or other gas that has been introduced into the conduit system to be trapped in the transport channel for easy removal for example by simply airing the transport channel.

As discussed above, the conduits of the battery device are in some embodiments interleaved. This is shown explicitly for the second row of conduits 12-2 in FIG. 16, where it is shown that two conduits are transporting the fluid in each direction. A transport channel will thus serve not only a single pair of conduits (in/out), but will serve at least two conduit pairs (in/in/out/out), for example 2, 3 or 4 pairs of conduits. As discussed above a transport channel may comprise a bent section connecting each conduit pair (where conduits are interleaved by their physical arrangement and provision of fluid through a common distribution conduit 19), or be of a more general shape, such as a rectangular box, where the fluid from possibly multiple conduits enter and exit where the flow and direction of flow is controlled by the pressure of the fluid. By interleaving conduits, a larger surface area for heat exchange is achieved at a lower pressure drop compared to connecting the conduits in series as discussed above.

As with all other embodiments herein and in contrast to prior art filters, where the conduits are arranged to also enable the battery device to act as a filter, the conduits 12 of the battery device 10 according to herein are not arranged to block the path of particles. The inventors have realized that as the conduit arrangement according to herein does not need to filter the passing gas flow and that a sufficient degree of heat exchange may still be achieved through the arrangement of conduits. The same (or at least negligibly less efficient) heat exchange may be achieved even when allowing the passing gas flow to pass unhindered in some gas channels. These gas channels are provided for by the distancing of the adjacent conduit arrangements at a vertical distance from one another. This vertical distancing is indicated by the vertical distance D3 in FIG. 16, as is also indicated in FIG. 6. The vertical distance D3 in FIG. 16 thus indicate a distance between two conduit arrangements (for example 12-2 and 12-3) that is bigger than zero measured from the lowest point of the upper conduit 12-2 arrangement to the upper point of the lower conduit arrangement 12-3, i.e. the width of the air channel indicated by the dotted arrow marked “ac”.

By providing the air channels allowing the air flow to pass through the battery device relatively unhindered the pressure needed to pump or blow the flow of air through the battery device 10 is reduced to an optimum minimum thereby reducing the power consumption of the ventilation system 1 and increasing the efficiency of both the battery device 10 and the ventilation system 1, making the battery device 10 highly beneficial for use as a battery device 10 in a ventilation system 1.

The inventors have also realized and researched that due to the high efficiency of the proposed structure the actual material used in the conduits are of less, or negligible importance, as the material's influence on the overall heat exchange is negligible. The inventors are therefore proposing that the ingenious design discussed herein may also be produced through 3D printing in any material, including various plastics.

In the prior art, producing heat exchangers haver required a substantive work effort both as regards the amount of work and the complexity of the work. Some heat exchangers have been produced through 3D printing mechanisms working with metals, but those have been extremely complicated and expensive. However, as the inventors have realized, a heat exchanger or a battery device for a heat exchanger as according to the teachings herein, which are so efficient that they may be produced using any material, makes it possible to work with plastic materials which makes the 3D printing significantly less complicated and substantially cheaper!

The contemporary understanding is that a heat exchanger especially for HVAC systems has to be made of metal, and to step away from this prevalent prejudice is not obvious and indicates an inventive step in itself! Furthermore, the work effort required to construct a metal heat exchanger has been a problem that has been around for many years.

FIG. 17 thus show an arrangement in which a 3D printer 100 produces a conduit arrangement 12 for use in a battery device 10 according to herein. The 3D printer may also be arranged to produce a layering of conduit arrangements 12-1, 12-2, 12-3, 12-4 as shown in the figures herein, where it also becomes apparent that the type or shape of transport channel 13a, 13b, 13c, 14a, 14b is of less importance as the work required for the mounting is not of importance, as the mounting is automated in the 3D printing process. As shown in FIG. 17, the 3D printer may be used to generate the battery device 10, with some or all parts including, but not limited to, the housing 11, the distribution channel 19, the collection channel 20, the conduit arrangements 12 and/or layering thereof, the conduits 13, 14, and the transport channels 13b, 14b. Not shown in FIG. 17 is that the 3D printer 100 may also be utilized to provide the distancing means (or supports) 17 for the conduit arrangements such as discussed in relation to FIGS. 7 and 8, possibly replacing such distancing supports as the mounting may be provided by the 3D printer, as would be apparent to a skilled person taking part of the teachings herein.

FIG. 18 shows a flowchart of the simple method of providing a battery device through a 3D printing methodology as discussed herein, wherein the method comprises 3D printing 810 at least one conduit arrangement 12 or parts thereof possibly including the distribution and/or collection conduits as disclosed herein.

It should be noted that all aspects and features discussed herein for the bent conduit arrangements discussed in relation to FIGS. 1 to 12 also apply to the general conduit arrangements discussed in relation to FIGS. 13 to 18, and that all aspects and features discussed herein for the general conduit arrangements discussed in relation to FIGS. 13 to 18 also apply to the bent conduit arrangements discussed in relation to FIGS. 1 to 13.The inventors have also realized that the ingenious arrangement discussed herein may not only be used in relation to a ventilation system for use in marine environments, dryer systems as well as kitchens or other system used with air carrying particles. As the manufacture of a heat exchanger is complicated regardless of the application of the resulting heat exchanger, all fields of use for heat exchangers will benefit form a heat exchanger as discussed herein, simply in the fact that it allows for manufacture using a great variety of materials, including plastics, and thus enables for being manufactured through 3D printing.

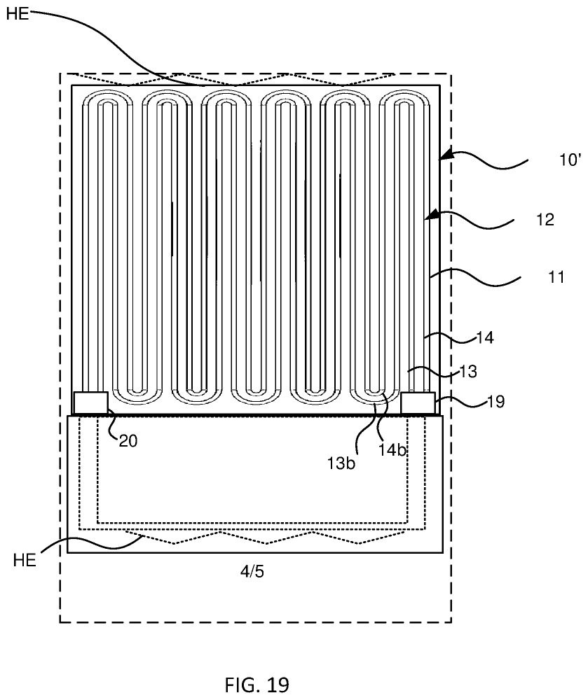

FIG. 19 shows a schematic view of a heat exchanger 10′ constructed along the same principals as the battery device 10 disclosed herein. All benefits and variations discussed with reference to the battery device 10 may also be applied to the heat exchanger 10′. FIG. 19 also shows how the heat exchanger can be comprised in a heat exchange system 4,5 or adapted to operate as a battery device for a heat exchange system 4,5. As a skilled person would understand a heat exchanging structure may be used both as a heat exchanger and or alternatively as a battery device and no more details on this will be given herein. The method disclosed with reference to FIG. 18 showing a flowchart of the simple method of providing a battery device through a 3D printing methodology as discussed herein, can thus also be used to provide a heat exchanger 10′ as disclosed herein wherein the method comprises 3D printing 810 at least one conduit arrangement 12 or parts thereof possibly including the distribution and/or collection conduits as disclosed herein to be used in the heat exchanger 10′.

Although the present invention has been described above with reference to specific embodiments, it is not intended to be limited to the specific form set forth herein.

One instance of the teachings herein discloses a heat exchanger 10′ arranged to exchange energy with a flow F of air, said heat exchanger 10′ comprises: a housing 11 arranged to receive said flow F of air through a first end 11a and at least one conduit arrangement 12 arranged inside said housing 11 whereby said flow F of air will pass along the at least one conduit arrangement 12 when said flow F of air is received by said housing 11, the heat exchanger 10′ being characterized in that at least one of said at least one conduit arrangement 12 is 3D printed from a plastic material.

In one embodiment of such an instance said at least one conduit arrangement 12 is arranged to extend in a direction from the first end of the housing 11a to a second end of the housing 11b, and wherein said at least one conduit arrangement 12 comprises a plurality of conduits 13, 14 comprising straight sections 12b interconnected with transport channels 12a, 13a, 13b, 13c, 14a, 14b, the straight sections 12b being arranged horizontally and in a direction substantially orthogonal relative the flow of air, and wherein the conduits are arranged to receive and transport a fluid in a general direction opposite the flow of air F.

In one embodiment of such an instance wherein at least one of said at least one conduit arrangement 12 comprises at least a first conduit 13 and a second conduit 14, wherein the first conduit 13 is arranged interleaved with the second conduit 14.

In one embodiment of such an instance the conduit 13 and the second conduit 14 are arranged in a pattern extending horizontally by being arranged at a tilt angle gamma being in the range of 5 to −5 degrees relative the direction of the flow of air.

In one embodiment of such an instance the first conduit 13 is parallel to the second conduit 14 in the straight sections 12b.

In one embodiment of such an instance the distance D1 between the first conduit 13 and the second conduit 14 in a straight section 12b equals the distance D2 between two straight sections 12b.

In one embodiment of such an instance a first conduit arrangement 12-1 is arranged parallel to a second conduit arrangement 12-2 at a vertical distance D3.

In one embodiment of such an instance the heat exchanger 10′ further comprises a distribution conduit 19 arranged at the second end 11b of the housing 11 to distribute a fluid to each conduit 13, 14, 15, 16 of the bent conduit arrangement 12 and a collection conduit 20 arranged at the first end 11a of the housing 11 to collect the fluid after it has been transported through said conduits 13, 14, 15, 16.

In one embodiment of such an instance the heat exchanger 10′ is comprised in a heat exchange system 4,5.

In one embodiment of such an instance the heat exchange system is for being utilized in a marine environment.

In one embodiment of such an instance the heat exchange system is for being utilized in a dryer system.

In one embodiment of such an instance the heat exchange system is for being utilized in a system used with air carrying particles.

A similar instance of the teachings herein discloses a method for providing a heat exchanger 10′ according to any of preceding claims, wherein the method comprises 3D printing 810 at least one conduit arrangement 12 from a plastic material.

One alternative or additional instance of the teachings herein discloses a battery device 10 arranged to be installed in a ventilation system 1 and arranged to extract energy from a flow F of air, said battery device 10 comprises: a housing 11 arranged to receive said flow F of air through a first end 11a and at least one bent conduit arrangement 12 arranged inside said housing 11 to extend in a direction from the first end of the housing 11a to a second end of the housing 11b, whereby said flow F of air will pass along the bent conduit arrangement 11 when said flow F of air is received by said housing 11, wherein said at least one bent conduit arrangement 12 comprises at least a first conduit 13 and a second conduit 14 arranged in a bent pattern extending in the direction of the bent conduit arrangement 12 and at a tilt angle gamma being in the range of 5 to −5 degrees relative the direction of the flow of air, wherein the first conduit 13 is arranged interleaved with the second conduit 14, wherein the bent pattern comprises bent section 12a and straight sections 12b, the straight sections 12b being arranged substantially horizontally and in a first direction relative the flow of air, and the bent sections 12a being arranged at the tilt angle.

In one embodiment of such an instance the first direction being 85-95 degrees, 88-92 degrees, 89-91 degrees or 90 degrees. In one embodiment of such an instance the tilt angle is in the range 1 to −5 degrees. In one embodiment of such an instance the tilt angle is in the range 1 to −2 degrees. In one embodiment of such an instance the tilt angle is substantially 0 degrees.

In one embodiment of such an instance the first conduit 13 is parallel to the second conduit 14 in the straight sections 12b.

In one embodiment of such an instance the first conduit 13 is arranged bent utilizing a first 13a and a second 13b bent section, the second conduit 14 is arranged bent utilizing a first 14a and a second 14b bent section, wherein the first bent section 13a of the first conduit 13 corresponds to the first bent section 14a of the second conduit 14 and the second bent section 13b of the first conduit 13 corresponds to the second bent section 14b of the second conduit 14.

In one embodiment of such an instance the first bent section 13a of the first conduit 13 equals the second bent section 14b of the second conduit 14 and the second bent section 13b of the first conduit 13 equals the first bent section 14a of the second conduit 14.

In one embodiment of such an instance the first bent section 13a and second bent section 13b of the first conduit 13 and the first bent section 14a and second bent section 14b of the second conduit 14 are horizontal.

In one embodiment of such an instance the radius of the first bent section 13a of the first conduit 13 is equal to 1.5-2.5 times a diameter of the first conduit 13 and wherein the radius of the second bent section 14b of the second conduit 14 is equal to 1.5-2.5 times a diameter of the first conduit 13.

In one embodiment of such an instance the distance D1 between the first conduit 13 and the second conduit 14 in a straight section 12b equals the distance D2 between two straight sections 12b.

In one embodiment of such an instance the bent conduit arrangement comprises a third conduit 15, wherein the third conduit 15 is arranged in between the first conduit 13 and the second 14.

In one embodiment of such an instance the third conduit 15 is arranged bent utilizing a repeated bending 15a.

In one embodiment of such an instance the bent conduit arrangement comprises a fourth conduit 16, wherein the fourth conduit 16 is arranged in between the first conduit 13 and the second 14 adjacent the third conduit 15.

In one embodiment of such an instance the third conduit 15 is arranged bent utilizing a first 15a and a second 15b bent section, the fourth conduit 16 is arranged bent utilizing a first 16a and a second 16b bent section, wherein the first bent section 15a of the third conduit 15 corresponds to the first bent section 16a of the fourth conduit 16 and the second bent section 15b of the third conduit 15 corresponds to the second bent section 16b of the fourth conduit 16.

In one embodiment of such an instance a first bent conduit arrangement 12-1 is arranged parallel to a second bent conduit arrangement 12-2 at a vertical distance D3.

In one embodiment of such an instance the battery device further comprises at least one support 17 having an upper side 17a and a lower side 17b, the at least one support 17 being arranged between the first bent conduit arrangement 12-1 and the second bent conduit arrangement 12-2, wherein said support 17 is arranged to extend in a direction parallel to the flow F of air and comprises cutouts 17C for receiving said first and second conduits 13, 14. In one embodiment of such an instance said cutouts 17C are arranged on one side 17a, 17b of the structure 17. In one embodiment of such an instance said cutouts 17C are arranged as upper cutouts on an upper side of the structure 17 and lower cutouts on a lower side of the structure 17.

In one embodiment of such an instance the upper side 17a of the structure 17 is arranged at an angle relative the lower side 17b of the structure 17. In one embodiment of such an instance the angle is in the range 1-45 degrees, 10-45 degrees, 20-45 degrees, or 30-45 degrees.

In one embodiment of such an instance the battery device comprises a first support 17-1 and a second support 17-2 wherein said first support 17-1 is arranged in the direction parallel to the flow F, and said second support 17-2 is arranged turned in the opposite direction.

In one embodiment of such an instance the battery device further comprises a distribution conduit 19 arranged at the second end 11b of the housing 11 to distribute a fluid to each conduit 13, 14, 15, 16 of the bent conduit arrangement 12 and a collection conduit 20 arranged at the first end 11a of the housing 11 to collect the fluid after it has been transported through said conduits 13, 14, 15, 16.

In one embodiment of such an instance the battery device is connected to a heat exchange system 4,5. In one embodiment of such an instance the heat exchange system is arranged for use in a marine environment. In one embodiment of such an instance the heat exchange system is arranged for use in a dryer system. In one embodiment of such an instance the heat exchange system is arranged for use in a system used with air carrying particles.

In one embodiment of such an instance the at least one conduit 13, 14 has an outer surface 28, the conduit 13, 14 being configured to receive a fluid, wherein the conduit 13, 14 is configured to have a first temperature TC1 and a second temperature TC2, wherein when the conduit 13, 14 has the first temperature TC1, condensation and a particle layer 25 of pollutants is formed on the outer surface 28 of the conduit 13, 14, and wherein when the conduit 13, 14 has the second temperature TC2 the condensation freezes and subsequently cracks the particle layer 25 such that the particle layer 25 is detached from the conduit 13, 14, thereby self-cleaning the battery device 10.

In one embodiment of such an instance the fluid is configured to have a first temperature TF1 and a second temperature TF2, wherein when the fluid has the first temperature TF1 the conduit 13, 14 has the first temperature TC1, and when the fluid has the second temperature TF2 the conduit 13, 14 has the second temperature TC2.

In one embodiment of such an instance the temperature of the conduit 13, 14 is regulated by the flow of air F.

In one embodiment of such an instance the temperature of the conduit 13, 14 is regulated by the flow of air F by reducing the flow of air.

In one embodiment of such an instance the self-cleaning battery device further comprises a shunting valve 29, wherein the temperature of the conduit 13, 14 is regulated by the flow of air F by shunting in cooler air into the flow of air.

In one embodiment of such an instance the conduit 13, 14 is caused to assume the second conduit temperature TC2 by causing the fluid to assume the second fluid temperature TF2 by regulating the temperature of the fluid.

In one embodiment of such an instance the conduit 13, 14 is arranged to first have a first temperature, then to have the second temperature, and then to have a temperature at least above 0 degrees Celsius. A similar instance of the teachings herein discloses a method for self-cleaning of a battery device 10 according to above, wherein the method comprises: causing 1102 the at least one conduit 13, 14 to assume a first temperature TC1, whereby condensation and a particle layer 25 of pollutants is formed on the outer surface 28 of the at least one conduit 13, 14; and causing 1106 the conduits 13, 14 to assume a second temperature TC2, whereby the condensation and the particle layer 25 freezes and subsequently cracks 1107 such that the particle layer 25 is detached from the at least one conduit 13, 14.

Although the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc. do not preclude a plurality. Reference signs in the claims are provided merely as a clarifying example and shall not be construed as limiting the scope of the claims in any way.

1.-40. (canceled)

41. A battery device arranged to be installed in a ventilation system and arranged to extract energy from a flow of air, said battery device comprises:
a housing arranged to receive said flow of air through a first end and
at least one conduit arrangement arranged inside said housing to extend in a direction from the first end of the housing to a second end of the housing, whereby said flow of air will pass along the conduit arrangement when said flow of air is received by said housing,
wherein said at least one conduit arrangement comprises at least a first conduit and a second conduit arranged in a pattern extending horizontally in the direction of the conduit arrangement,
wherein the first conduit is arranged interleaved with the second conduit, wherein the pattern comprises transport channels and straight sections, the straight sections being arranged horizontally and in a first direction relative the flow of air,
wherein the at least a first conduit and a second conduit are arranged in a bent pattern extending in the direction of the bent conduit arrangement and at a tilt angle (gamma) being in the range of 5 to −5 degrees relative the direction of the flow of air,
wherein the bent pattern comprises at least one bent section and a plurality of straight sections, each of the straight sections being arranged substantially horizontally and in a first substantially perpendicular direction relative the flow of air, and the at least one bent section being arranged at the tilt angle.

42. The battery device according to claim 41, wherein the first conduit is parallel to the second conduit in the straight sections.

43. The battery device according to claim 41, wherein the first conduit is arranged bent utilizing a first and a second bent section, the second conduit is arranged bent utilizing a first and a second bent section, wherein the first bent section of the first conduit matches the corresponding first bent section of the second conduit and the second bent section of the first conduit matches the corresponding second bent section of the second conduit.

44. The battery device according to claim 41, wherein the first bent section and second bent section of the first conduit and the first bent section and second bent section of the second conduit are horizontal.

45. The battery device according to claim 41, wherein the radius of the first bent section of the first conduit is equal to 1.5-2.5 times a diameter of the first conduit and wherein the radius of the second bent section of the second conduit is equal to 1.5-2.5 times a diameter of the first conduit.

46. The battery device according to claim 41, wherein the distance between the first conduit and the second conduit in a straight section equals the distance between two straight sections, and wherein a first bent conduit arrangement is arranged parallel to a second bent conduit arrangement at a vertical distance.

47. The battery device according to claim 41, wherein the bent conduit arrangement comprises a third conduit, wherein the third conduit is arranged in between the first conduit and the second, wherein the third conduit is arranged bent utilizing a repeated bending, wherein the bent conduit arrangement comprises a fourth conduit, wherein the fourth conduit is arranged in between the first conduit and the second adjacent the third conduit.

48. The battery device according to claim 47, wherein the third conduit is arranged bent utilizing a first and a second bent section, the fourth conduit is arranged bent utilizing a first and a second bent section, wherein the first bent section of the third conduit corresponds to the first bent section of the fourth conduit and the second bent section of the third conduit corresponds to the second bent section of the fourth conduit.

49. The battery device according to claim 41, further comprising at least one support having an upper side and a lower side, the at least one support being arranged between the first bent conduit arrangement and the second bent conduit arrangement, wherein said support is arranged to extend in a direction parallel to the flow of air and comprises cutouts for receiving said first and second conduits.

50. The battery device according to claim 41, further comprising a distribution conduit arranged at the second end of the housing to distribute a fluid to each conduit of the bent conduit arrangement and a collection conduit arranged at the first end of the housing to collect the fluid after it has been transported through said conduits.

51. A battery device according to claim 41, wherein the at least one conduit has an outer surface, the conduit being configured to receive a fluid, wherein the conduit is configured to have a first temperature (TC1) and a second temperature (TC2), wherein when the conduit has the first temperature (TC1), condensation and a particle layer of pollutants is formed on the outer surface of the conduit, and wherein when the conduit has the second temperature (TC2) the condensation freezes and subsequently cracks the particle layer such that the particle layer is detached from the conduit, thereby self-cleaning the battery device, wherein the fluid is configured to have a first temperature (TF1) and a second temperature (TF2), wherein when the fluid has the first temperature (TF1) the conduit has the first temperature (TC1), and when the fluid has the second temperature (TF2) the conduit has the second temperature (TC2).

52. The battery device according to claim 51, wherein the temperature of the conduit is regulated by the flow of air, wherein the battery device further comprises a shunting valve (29) and wherein the temperature of the conduit is regulated by the flow of air by shunting in cooler air into the flow of air.

53. A heat exchanger arranged to exchange energy with a flow of air, said heat exchanger comprises:
a housing arranged to receive said flow of air through a first end and
at least one conduit arrangement arranged inside said housing whereby said flow of air will pass along the at least one conduit arrangement when said flow of air is received by said housing, the heat exchanger being characterized in that
at least one of said at least one conduit arrangement is 3D printed from a plastic material.

54. The battery device according to claim 41, arranged to be used in a marine environment or in a kitchen system.

55. A method for self-cleaning of a battery device according to claim 51, wherein the method comprises:
causing (1102) the at least one conduit to assume a first temperature (TC1), whereby condensation and a particle layer of pollutants is formed on the outer surface of the at least one conduit; and
causing the conduits to assume a second temperature (TC2), whereby the condensation and the particle layer freezes and subsequently cracks such that the particle layer is detached from the at least one conduit.
